(19) United States
(12) Patent Application Publication
(10) Pub. No.: US 2019/0041017 A1
(43) Pub. Date: Feb. 7, 2019

(54) DAYLIGHTING BLIND, DAYLIGHTING DEVICE, AND LIGHTING SYSTEM

(71) Applicant: SHARP KABUSHIKI KAISHA, Sakai City, Osaka (JP)

(72) Inventors: HIDEOMI YUI, Sakai City (JP); TSUYOSHI KAMADA, Sakai City (JP); MASAHIRO TSUJIMOTO, Sakai City (JP)

(21) Appl. No.: 16/073,166

(22) PCT Filed: Jan. 25, 2017
(86) PCT No.: PCT/JP2017/002486

§ 371 Date: Jul. 26, 2018

(30) Foreign Application Priority Data
Jan. 29, 2016 (JP) 2016-016637

(51) Int. Cl. F21S 19/00; E06B 9/305; E06B 9/322; E06B 9/68; H05B 37/02; F21S 11/00

(52) U.S. Cl. CPC F21S 19/005; E06B 9/305; E06B 9/322; E06B 2009/2417; H05B 37/0218; F21S 11/007; E06B 9/68

(57) ABSTRACT

A daylighting blind according to an aspect of the invention includes: a plurality of slats; and a support mechanism that interconnects the plurality of slats, a longitudinal direction of which is oriented in a horizontal direction, and supports the plurality of slats suspended in a vertical direction. At a boundary between a daylighting slat group composed of a plurality of daylighting slats in an upper position in the vertical direction and a light-shielding slat group composed of a plurality of light-shielding slats in a lower position in the vertical direction, the daylighting slats and the light-shielding slats are arranged consecutively. The support mechanism includes a lifting/lowering member that causes the daylighting slat group to be stored or extend independently.

### TECHNICAL FIELD

Several aspects of the present invention relate to a daylighting blind, a daylighting device, and a lighting system.

The present application claims priority based on Japanese Patent Application No. 2016-016637, filed in Japan on Jan. 29, 2016, which is incorporated herein by reference.

### BACKGROUND ART

Generally, with known daylighting devices provided for openings, such as windows, for the purpose of using daylight, it is difficult to switch between a daylighting function and a light shielding function as appropriate, and when light shielding is desired at a conference or the like, it is necessary to additionally use a curtain or a blind for light shielding purposes.

Patent Literature 1 describes a blind which includes a region having a plurality of transparent first slats and a region having a plurality of opaque second slats. Each of the first slats includes a transparent portion that enables visible light to be transmitted through the slat, and deflects light transmitted through the transparent portion so as to change the propagation direction of the light.

### CITATION LIST

### Patent Literature

Patent Literature 1: Japanese Unexamined Patent Application Publication No. 2014-224434

### SUMMARY OF INVENTION

### Technical Problem

However, with a known construction, in which the transparent slats are used, it is difficult to completely block the light entering through the entire window. Namely, because both transparent slats and opaque slats are used in the known construction, it is difficult to use a light shielding function alone.

In view of the foregoing problem of the related art, an aspect of the present invention aims to provide a daylighting blind, a daylighting device, and a lighting system which enable a daylighting function and a light shielding function to be performed independently of each other.

### Solution to Problem

A daylighting device according to an aspect of the invention includes: a plurality of slats; and a support mechanism that interconnects the plurality of slats, a longitudinal direction of which is oriented in a horizontal direction, and supports the plurality of slats suspended in a vertical direction. At a boundary between a daylighting slat group composed of a plurality of daylighting slats in an upper position in the vertical direction and a light-shielding slat group composed of a plurality of light-shielding slats in a lower position in the vertical direction, the daylighting slats and the light-shielding slats are arranged consecutively. The support mechanism includes a lifting/lowering member that causes the daylighting slat group to be stored or extend independently.

In the daylighting blind according to the aspect of the invention, the support mechanism may be a mechanism to store the daylighting slat group and store the light-shielding slat group after the daylighting slat group is stored.

In the daylighting blind according to the aspect of the invention, the support mechanism may include: a storage box that stores the plurality of slats; the lifting/lowering member having one system shared by the plurality of daylighting slats and the plurality of light-shielding slats; and a pulley connected to the storage box and supporting the lifting/lowering member.

In the daylighting blind according to the aspect of the invention, the support mechanism may include the lifting/lowering member having two systems each provided for a corresponding one of the daylighting slat group and the light-shielding slat group, and the support mechanism causes the daylighting slat group and the light-shielding slat group to be stored independently of each other by using the lifting/lowering member having the two systems.

The daylighting blind according to the aspect of the invention may further include two rotation shafts each supporting a corresponding one of the two systems of the lifting/lowering member.

The daylighting blind according to the aspect of the invention may further include a diffusing slat group composed of a plurality of diffusing slats disposed below the light-shielding slat group in the vertical direction.

In the daylighting blind according to the aspect of the invention, the support mechanism may include the lifting/lowering member having three systems each provided for a corresponding one of the daylighting slat group, the light-shielding slat group, and the diffusing slats. The support mechanism causes the daylighting slat group, the light-shielding slat group, and the diffusing slat group to be stored independently of one another by using the lifting/lowering member having the three systems.

The daylighting blind according to the aspect of the invention may further include three rotation shafts each supporting a corresponding one of the three systems of the lifting/lowering member.

In the daylighting blind according to the aspect of the invention, a length of the light-shielding slat group, composed of the plurality of light-shielding slats, in the vertical direction may be greater than a length of a window in the vertical direction.

A daylighting device according to another aspect of the invention includes: a first substrate having a light transmitting property and a second substrate having a light transmitting property and disposed opposing the first substrate; and a daylighting blind disposed between the first substrate and the second substrate. The above-mentioned daylighting blind is used as the daylighting blind.

A lighting system according to still another aspect includes: a daylighting device; room lighting equipment; a detection section that detects brightness in a room; and a control section that controls the room lighting equipment and the control section. The above-mentioned daylighting blind or the above-mentioned daylighting device is used as the daylighting device.

### Advantageous Effects of Invention

According to several aspects of the invention, a daylighting blind, a daylighting device, and a lighting system which enable the daylighting function and the light shielding function to be performed independently of each other.

### BRIEF DESCRIPTION OF DRAWINGS

FIG. 1 is a perspective view illustrating an outer appearance of a blind according to a first embodiment.

FIG. 2 is a side view illustrating the blind according to the first embodiment.

FIG. 3A is a front view illustrating a general construction of daylighting slats forming a daylighting region.

FIG. 3B is a sectional view, taken along line A-A′ of FIG. 3A, illustrating the general construction of the daylighting slats forming the daylighting region.

FIG. 4A is a perspective view of a daylighting sheet.

FIG. 4B is a sectional view of a daylighting section.

FIG. 5 is a view illustrating a lifting/lowering cord of the blind according to the first embodiment.

FIG. 6A is a perspective view illustrating main parts of the blind at an enlarged scale, and particularly illustrating an opened state of the blind.

FIG. 6B is a perspective view illustrating the main parts of the blind at an enlarged scale, and particularly illustrating a closed state of the blind.

FIG. 7 is a schematic view illustrating an example of a room model having the blind installed therein.

FIG. 8 is a perspective view for explaining a daylighting function and a light shielding function of the blind.

FIG. 9 is a view for explaining the daylighting function by the daylighting slat.

FIG. 10A is a first view illustrating a state of use of the daylighting blind.

FIG. 10B is a second view illustrating a state of use of the daylighting blind.

FIG. 10C is a third view illustrating a state of use of the daylighting blind.

FIG. 11 is a view illustrating a daylighting state provided by the daylighting blind according to the first embodiment.

FIG. 12 is a view illustrating a light shielding state provided by the daylighting slats in the first embodiment.

FIG. 13 is a view illustrating behavior of a planetary gear mechanism at the time of storing a daylighting slat group.

FIG. 14 is a view illustrating behavior of the planetary gear mechanism at the time of storing the daylighting slat group.

FIG. 15 is a perspective view illustrating an outer appearance of a daylighting blind according to a second embodiment.

FIG. 16 is a view illustrating a general construction of a lifting/lowering operation section (roll-up mechanism) in the second embodiment.

FIG. 17A is a view illustrating a state where only the daylighting slat group of the blind according to the second embodiment is held in a stored position.

FIG. 17B is a view illustrating a state where only the light-shielding slat group of the blind according to the second embodiment is held in the stored position.

FIG. 18 is a view illustrating a light shielding state of the blind according to the second embodiment.

FIG. 19 is a view illustrating a daylighting state of the blind according to the second embodiment.

FIG. 20 is a view illustrating a daylighting state of the blind according to the second embodiment.

FIG. 21 is a view illustrating a state where the daylighting slats of the blind according to the second embodiment are oriented in a horizontal direction.

FIG. 22 is a view illustrating a state where the light-shielding slats of the blind according to the second embodiment are oriented in a horizontal direction.

FIG. 23 is a view illustrating a state where the light-shielding slat group of the blind according to the second embodiment is held in the stored position.

FIG. 24 is a perspective view illustrating an outer appearance of a daylighting blind according to a third embodiment.

FIG. 25A is a view illustrating a state where only a diffusing slat group of the blind according to the third embodiment is held in the stored position.

FIG. 25B is a view illustrating a state where the daylighting slat group and the diffusing slat group of the blind according to the third embodiment are held in the stored position.

FIG. 25C is a view illustrating a state where the light-shielding slat group and the diffusing slat group of the blind according to the third embodiment are held in the stored position.

FIG. 26 is a view illustrating various functions performed by the blind according to the third embodiment.

FIG. 27 is a sectional view illustrating the length relationship between a blind according to a fourth embodiment and a window.

FIG. 28 is a view illustrating a state of use of the blind where a length of the light-shielding slat group in the vertical direction is smaller than a length of a windowpane in the vertical direction.

FIG. 29 is a view illustrating a state of use of the blind according to the fourth embodiment.

FIG. 30 is a view schematically illustrating a daylighting device according to an aspect of the invention.

FIG. 31 is a view illustrating a state of use of the daylighting device according to the aspect of the invention.

FIG. 32A is a sectional view illustrating a case where the blind is disposed on a room side of the windowpane.

FIG. 32B is a view illustrating an outer appearance of the blind in the case where the blind is disposed on a room side of the windowpane.

FIG. 33A is a sectional view illustrating the daylighting device according to an aspect of the invention.

FIG. 33B is a sectional view illustrating an outer appearance of the daylighting device according to the aspect of the invention.

FIG. 34 is a sectional view, taken along line B-B′ of FIG. 35, which illustrates a room model equipped with a daylighting device and a lighting control system.

FIG. 35 is a plan view illustrating a ceiling of the room model.

FIG. 36 is a graph illustrating data stored in the “Solar Radiation Database” of the New Energy and Industrial Technology Development Organization (NEDO).

### DESCRIPTION OF EMBODIMENTS

A detailed description will hereinafter be given of a daylighting blind, a daylighting device, and a lighting system according to several aspects of the invention.

Note that in respective figures to be described below, elements may be illustrated at different dimensional scales as appropriate for easier viewing of the elements.

Further, in the following description, positional relationships (upper and lower, left and right, and front and rear) of the daylighting device are based on positional relationships (upper and lower, left and right, and front and rear) of the daylighting device when in use, and also in the drawings, positional relationships of the daylighting device correspond to positional relationships relative to the surface of the sheet of the drawings unless otherwise described.

### First Embodiment

Hereinafter, the daylighting blind according to a first embodiment of the invention is described.

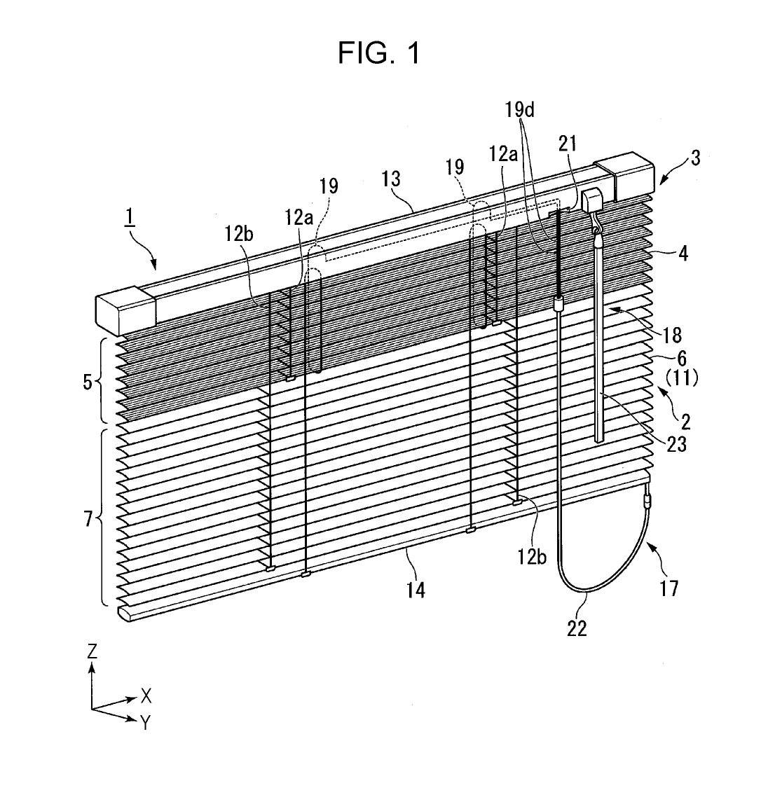

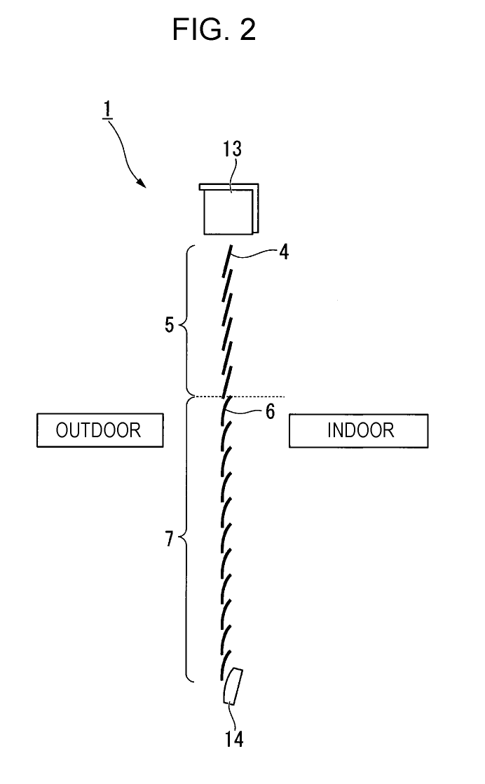

FIG. 1 is a perspective view illustrating an outer appearance of the blind according to the first embodiment. An up-down or vertical direction of the blind in FIG. 1 is denoted as the Z direction, a left-right or horizontal direction of the blind is denoted as the X direction, and a front-rear direction of the blind is denoted as Y direction. FIG. 2 is a side view of the blind according to the first embodiment.

As illustrated in FIG. 1, the blind (daylighting device) 1 according to the embodiment includes, as main components, a plurality of slats 2 extending in a horizontal direction (X direction) and arranged in a parallel with a space between adjacent sluts, and a support mechanism 3 that supports the plurality of slats 2 in such a manner that the slats 2 can be supported vertically, i.e., in the vertical direction (Z direction). Thus, in the blind 1, the plurality of slats 2 are supported vertically in a movable and tiltable manner.

As illustrated in FIGS. 1 and 2, the plurality of slats 2 includes: a daylighting slat group 5 composed of a plurality of upper daylighting slats 4 having a daylighting property; and a light-shielding slat group 7 composed of a plurality of light-shielding slats 6 having a light shielding property and disposed in a lower portion of the blind 1. In the following description, the daylighting slats 4 and the light-shielding slats 6 will be collectively referred to simply as “slats 2” unless it is necessary to particularly distinguish between the daylighting slats 4 and the light-shielding slats 6.

At a boundary between the daylighting slat group 5 and the light-shielding slat group 7 in the embodiment, the daylighting slats 4 and light-shielding slats 6 are arranged in a consecutive manner.

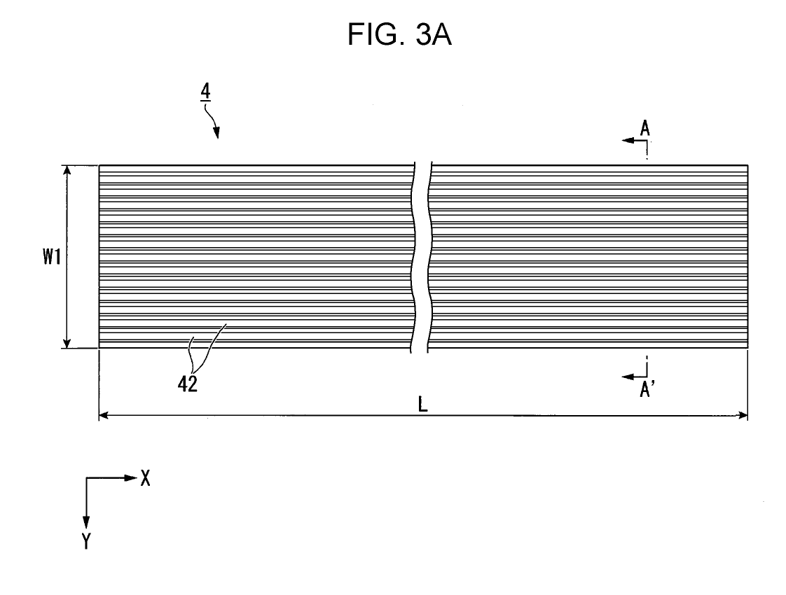

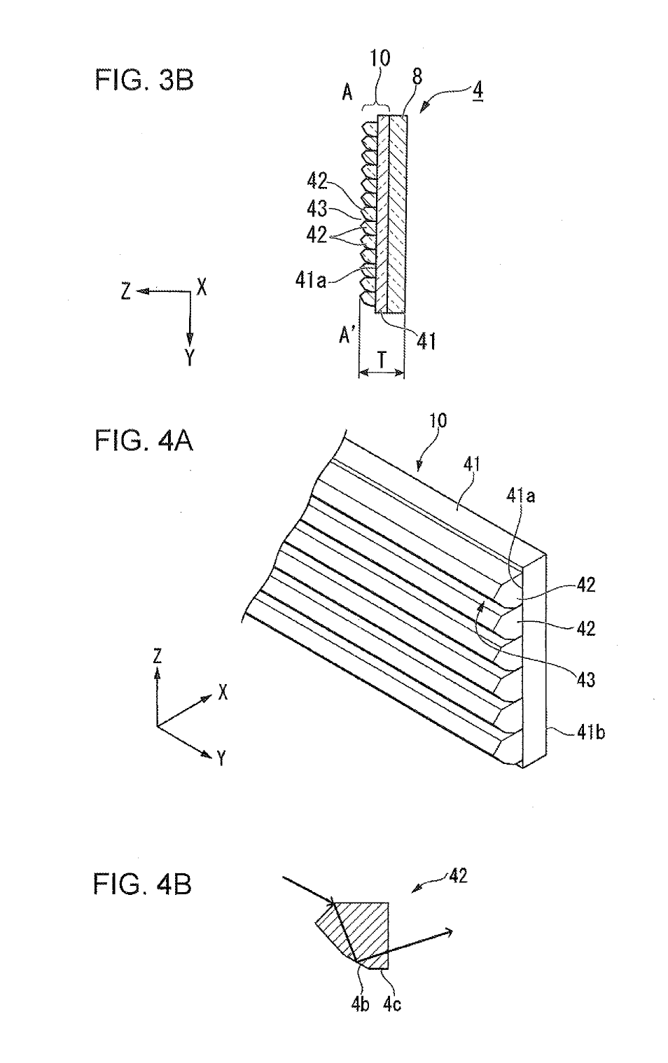

FIGS. 3A and 3B are views schematically illustrating the daylighting slats forming a daylighting region, where FIG. 3A is a front view and FIG. 3B is a sectional view taken along line A-A′ of FIG. 3A.

As illustrated in FIGS. 3A and 3B, each of the daylighting slats 4 composing the daylighting slat group 5 includes a slat body 8 extending in one direction, and a daylighting sheet (daylighting member) 10 provided on one surface of the slat body 8. The daylighting slat 4 has a longitudinal length L of about 1000 mm, a lateral length (slat width) W1 of about 25 mm, and a thickness T of 1 mm.

The slat body 8 includes a base member formed in an elongated plate shape and having a light transmitting property.

As illustrated in FIG. 3A, the daylighting sheet 10 includes: a base member 41 having a rectangular shape in the cross section (A-A′) perpendicular to the longitudinal direction (X direction); a plurality of daylighting sections 42 having a light transmitting property and provided on a first surface 41a of the base member 41; and gap sections 43 provided between the daylighting sections 42.

The base member 41 is formed of a light transmitting resin, such as a thermoplastic polymer, a thermosetting resin, or a photopolymerizable resin. As the light transmitting resin, one that is formed of any of an aclyric polymer, an olefin polymer, a vinyl polymer, a cellulosic polymer, an amide polymer, a fluorocarbon polymer, a urethane polymer, a silicone polymer, imide polymer, and the like is used. Particularly, for example, any of polymethylmethacrylate resin (PMMA), triacetyl cellulose (TAC), polyethylene terephthalate (PET), a cyclo olefin polymer (COP), a polycarbonate (PC), polyethylene naphthalate (PEN), a polyether sulphone (PES), a polyimide (PI), and the like may be suitably used. It is preferable that the total light transmittance of the base member 41 be 90% or more as determined in accordance with the provision of JIS K7361-1. In this way, sufficient transparency is achievable.

The daylighting sections 42 are each formed, for example, of an organic material having a light transmitting property and light sensitivity, such as an acrylic resin, an epoxy resin, or a silicone resin. Such an organic material, a polymerization initiator, a coupling agent, a monomer, organic solvent, and the like may be mixed and used. Further, the polymerization initiator may contain various additive agents, such as a stabilizer, inhibitor, plasticizer, fluorescent whitener, mold release agent, chain transfer agent, other photopolymerizable monomers, and the like. Alternatively, the materials described in Japanese Patent No. 4129991 may be used. It is preferable that the total light transmittance of the daylighting section 42 be 90% or more as determined in accordance with the provision of JIS K7361-1. In this way, sufficient transparency is achievable.

The daylighting sections 42 composing the daylighting slat 4 extend in the longitudinal direction (X direction) of the base member 41 and are arranged side-by-side in the lateral direction (Y direction) of the base member 41. Each of the daylighting sections 42 forms a prism body having a hexagonal sectional shape. Note, however, that the shape of the daylighting section 42 is not particularly limited to such a hexagonal sectional shape and may be of any other sectional shape, such as a pentagonal or triangular sectional shape or multi-tapered sectional shape. Thus, once sunlight transmitted through a windowpane enters the daylighting section 42, the light is reflected within the daylighting section 42 and then exits obliquely upward, as illustrated in FIG. 4A.

Although air (gap sections 43) exists between the plurality of daylighting sections 42 in the illustrated example, gap between the daylighting sections 42 may be filled with a low-refractive-index material other than air. However, a difference in the refractive index at an interface between the daylighting section 42 and the gap section 43 is maximized in the case where air exists compared with the case where a low-refractive-index material other than air exists outside the daylighting section 42. Thus, in the case where air exists between the daylighting sections 42a, a critical angle of light that has entered the daylighting section 42 and that is totally reflected by a reflective surface 4b or 4c is minimized according to Snell's law, as illustrated in FIG. 4B. Accordingly, a range of incident angles of light totally reflected by the reflective surface 4b or 4c is maximized, and the light having entered the daylighting section 42 can be efficiently directed toward a second surface 41b (see FIG. 4A) of the base member 41. As a result, loss of the light having entered the daylighting sections 42 can be minimized, and therefore luminance of light emitted from the other surface of the base member 41 can be increased.

It is desirable that the refractive index of the base member 41 and the refractive index of the daylighting section 42 be substantially equal to each other. In the case where the refractive indexes of the base member 41 and the daylighting section 42 differ greatly from each other, unnecessary light reflection and refraction may occur at the interface between the daylighting section 42 and the base member 41 when light enters the base member 41 through the daylighting section 42. In such a case, there may be inconveniences of a desired daylighting property not being achievable and luminance of the emitted light decreasing.

Referring back to FIG. 1, the light-shielding slats 6 composing the light-shielding slat group 7 each include a light shielding base member 11 formed in an elongated plate shape and having a light shielding property. The light shielding base members 11, which are commonly used as a blind slat, are formed, for example, of a metal, such as aluminum, a wood or a resin. Further, the light shielding base member 11 may have paint, a coating, or the like applied to its surface.

All of the light-shielding slats 6 composing the light-shielding slat group 7 not necessarily have a high light shielding property. For example, some of the light-shielding slats 6 composing the light-shielding slat group 7 may be slats having a light diffusing property or colored slats having a light transmitting property. In the case where all or some of the light-shielding slats 6 are constructed as slats having a light diffusing property or colored slats, it is possible to increase brightness in a room compared with the case where all of the light-shielding slats 6 are constructed as slats completely blocking external light.

Further, the aforementioned arrangements can not only achieve a comfortable indoor environment while preventing excessive glare from entering the line of sight of any person and a personal computer monitor present in the room, but also eliminate a possibility of the room being viewed from outside and thereby secure the privacy of room occupants.

The support mechanism 3 includes: a pair of daylighting-slat ladder cords 12a provided for the daylighting slat group 5; a pair of light-shielding-slat ladder cords 12b provided for the light-shielding slat group 7; a fixed box (housing or storage box) 13 that supports respective upper end portions of the ladder cords 12a and 12b; and a lifting/lowering bar 14 mounted on respective lower end portions of the light-shielding-slat ladder cords 12b.

In the following description, the daylighting-slat ladder cords 12a and the light-shielding-slat ladder cords 12b will be collectively referred to simply as “ladder cords 12” unless it is necessary to particularly distinguish between the daylighting-slat ladder cords 12a and the light-shielding-slat ladder cords 12b.

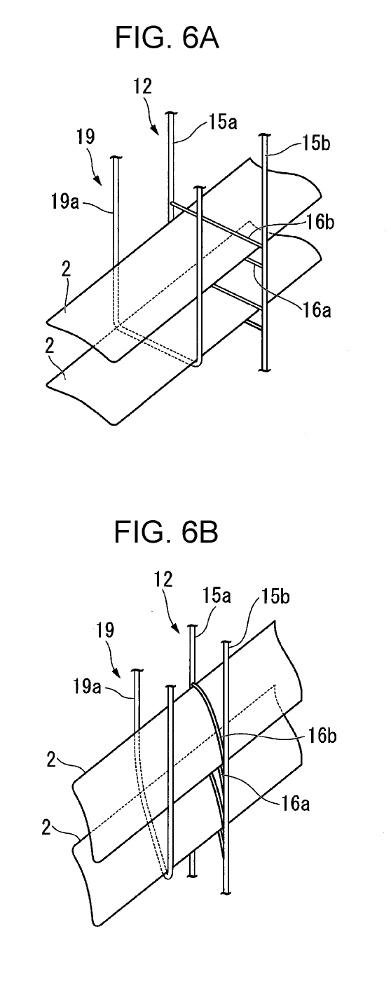

FIGS. 6A and 6B are perspective views illustrating main parts of the blind 1 at an enlarged scale, where FIG. 6A illustrates a state where the slats 2 are opened apart from each other and FIG. 6B illustrates a state where a gap between the slats 2 is closed.

As illustrated in FIG. 1, a pair of the ladder cords 12a and a pair of the ladder cords 12b are disposed on left and right portions of the plurality of slats 2 with a center portion in between, one of the pair of the ladder cords 12a is located on the left portion and the other thereof on the right portion and one of the pair of the ladder cords 12b is located on the left portion and the other thereof on the right portion. As illustrated in FIGS. 6A and 6B, each of the ladder cords 12 includes a pair of parallel front and rear vertical cords 15a and 15b and a pair of upper and lower horizontal cords 16a and 16b, and such horizontal cords 16a and 16b are disposed at equal intervals in a longitudinal (vertical) direction of the vertical cords 15a and 15b. Each of the slats 2 is disposed so as to be inserted between the vertical cords 15a and 15b and between one of the pairs of horizontal cords 16a and 16b.

As illustrated in FIG. 1, the fixed box 13 is located at the top of the plurality of parallel slats 2 disposed parallel to each other. The lifting bar 14 is located, on the other hand, at the bottom of the plurality of parallel-arranged slats 2 disposed parallel to each other. As illustrated in FIGS. 1, 6A, and 6B, the vertical cords 15a and 15b composing each of the ladder cords 12a and 12b are suspended from the fixed box 13 while being pulled vertically downward by the weight of the lifting bar 14.

The support mechanism 3 includes a lifting/lowering operation section 17 for lifting and lowering the plurality of slats 2, and a tilting operation section 18 for tilting the plurality of slats 2.

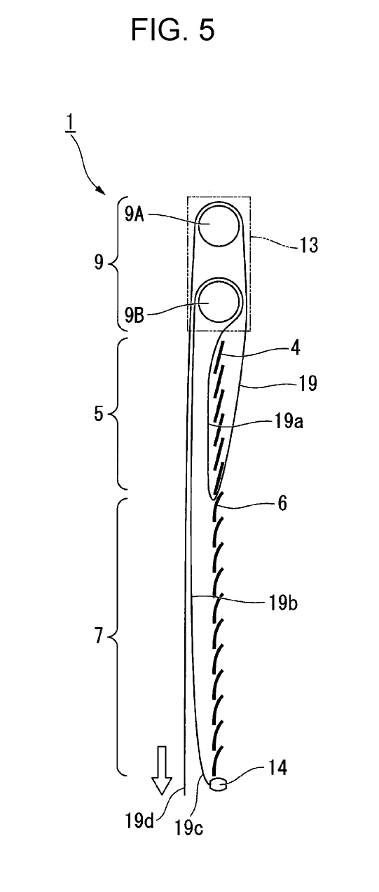

As illustrated in FIGS. 1 and 5, the lifting/lowering operation section 17 includes: two lifting/lowering cords (lifting/lowering members) 19; an operating cord 22; and a compound pulley 9.

The two lifting/lowering cords 19 are disposed as a pair of parallel cords disposed on left and right portions of the plurality of slats 2 with a center portion in between, and one of the pair is located on the left portion and the other thereof on the right portion. Each of the lifting/lowering cords 19 is disposed parallel to the vertical cords 15a and 15b of the ladder cord 12 (see FIGS. 6A and 6B). As illustrated in FIG. 1, one end portion of each of the lifting/lowering cords 19 is connected to the lifting/lowering bar 14.

As illustrated in FIG. 1, respective other end portions 19d of the two lifting/lowering cords 19 extend within the fixed box 13 and then are pulled out of a window section 21 provided at one side of the fixed box 13. The other end portions 19d of the two lifting/lowering cords 19 thus pulled out of the window section 21 are connected to one end of the operating cord 22. The other end of the operating cord 22 is connected to one end portion of the lifting/lowering bar 14.

Each of the lifting/lowering cords 19 is provided for and shared by the daylighting slat group 5 composed of the plurality of daylighting slats 4 and the light-shielding slat group 7 composed of the plurality of light-shielding slats 6, and enables the daylighting slat group 5 and the light-shielding slat group 6 to be stored in this order. More specifically, as illustrated in FIG. 5, each of the lifting/lowering cords 19 includes a first section 19a for lifting and lowering the plurality of daylighting slats 4 and a second section 19b for lifting and lowering the plurality of light-shielding slats 6.

The compound pulley 9 includes a first pulley 9A and a second pulley 9B disposed within the fixed box 13 with their respective axes extending parallel to each other. The above-mentioned lifting/lowering cords 19 are wound around the first and second pulleys 9A and 9B. Each of the lifting/lowering cords 19 is provided for and shared by the daylighting slat group 5 and the light-shielding slat group 7 and is wound around the first and second pulleys 9A and 9B.

More specifically, one of the lifting/lowering cords 19 extends from one end portion 19c thereof, which is connected to the lifting/lowering bar 14, along one surface of the blind 1 and is then wound around the second pulley 9B. Further, the lifting/lowering cord 19 is passed through the boundary between the daylighting slat group 5 and the light-shielding slat group 7, to surround the daylighting slat group 5 and is wound around the first pulley 9A as well. As described above, the other end portion 19b of the lifting/lowering cord 19 is connected to the operating cord (FIG. 1).

Each of the pair of lifting/lowering cords 19 in the embodiment is disposed outside of the slats 2.

In the construction of the related art, the lifting/lowering cords 19 are passed through holes formed in the slats 2. The slats 2 in the embodiment, in contrast, have no holes through which the lifting/lowering cords 19 are passed. Thus, the embodiment can prevent leakage of light through holes of the slats during the light shielding and thereby the light shielding performance of the blind 1 is enhanced.

In the lifting/lowering operation section 17, each of the pulleys 9A and 9B is rotated by the operating cord 22 being pulled in the state where the lifting/lowering bar 14 is located at its lowest position, and thus, the first section 19a of the lifting/lowering cord 19 is pulled into the fixed box 13 so that the daylighting slat group 5 is stored. After the daylighting slat group 5 is stored in this manner, the second section 19b of the lifting/lowering cord 19 is pulled into the fixed box 13 while moving around the periphery of each of the pulleys 9A and 9B so as to store the light-shielding slat group 7. Thus, in the embodiment, the light-shielding slat group 7 is stored following the storage of the daylighting slat group 5.

Both the lifting/lowering cords 19 are fixed in position via a stopper (not shown) provided within the window section 21. The lowest daylighting slat 4 can be fixed at a desired height position when the daylighting slat group 5 is stored, and in addition the lifting/lowering bar 14 can be fixed at a desired height position when the light-shielding slat group 7 is stored.

In the blind 1 according to the embodiment, the daylighting slat group 5 is stored first and then the light-shielding slat group 7 is stored. When these slat groups 5 and 7 are to be extended from their stored positions, the slat groups 5 and 7 are extended by releasing the fixation, by the stopper, of the lifting/lowering cords 19. In this way, the light-shielding slat group 7 can be extended after the lifting/lowering bar 14 is brought to its extended or lowest position, and the daylighting slat group 5 can then be extended.

As illustrated in FIG. 1, the tilting operation section 18 includes an operating lever 23 provided on one side of the fixed box 13. The lever 23 is provided to be pivotable about its axis. By such axial pivotal movement of the lever 23, the tilting operation section 18 can cause the vertical cords 15a and 15b, composing the ladder cord 12 illustrated in FIG. 6A, to move in opposite vertical directions. Thus, the plurality of slats 2 can be tilted synchronously with one another between the position where the slats 2 are opened apart from one another as illustrated in FIG. 6A and the position where the slats 2 are closed as illustrated in FIG. 6B.

The blind 1 constructed as described above is disposed vertically suspended from above the windowpane or the like and with the plurality of slats 2 opposed to the inner surface of the windowpane. Specifically, the daylighting slat group 5 is disposed with the daylighting sections 42 (FIGS. 3A and 3B) of the individual daylighting slats 4 facing the windowpane.

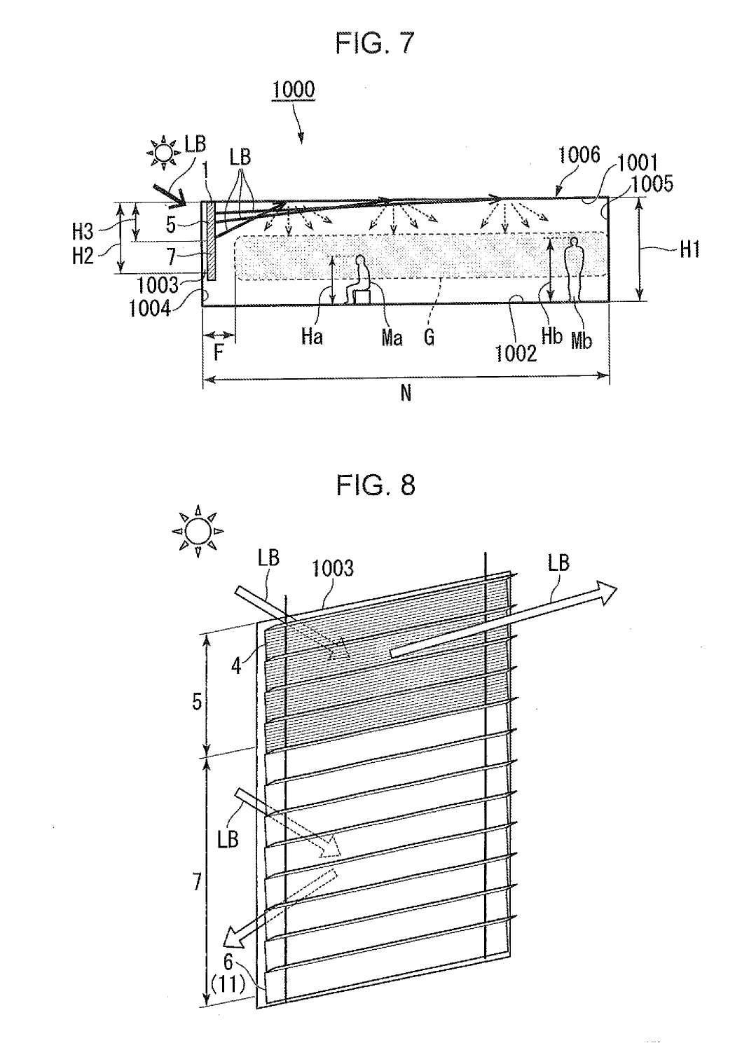

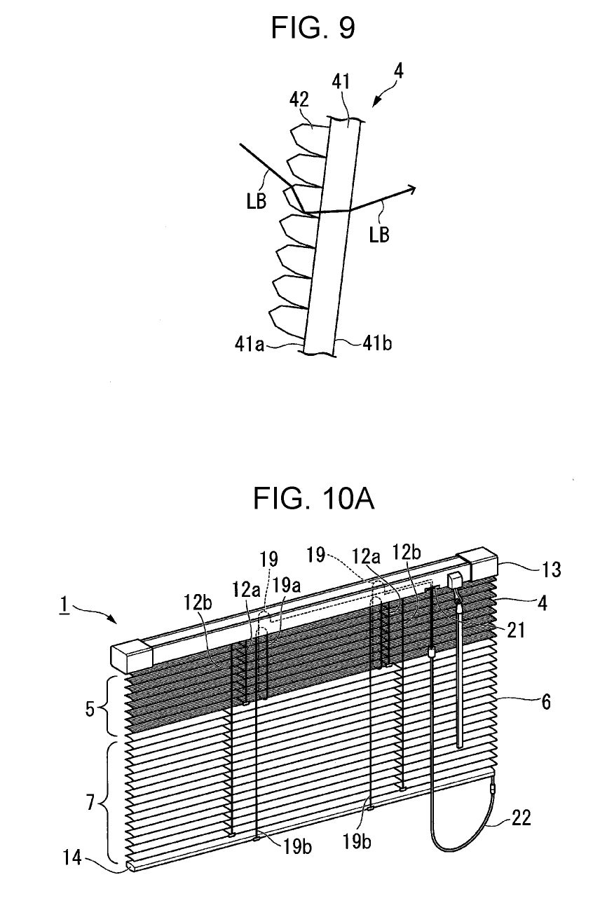

Here, a description will be given of the daylighting function and the light shielding function of the blind 1, by using a room model 1000 illustrated in FIG. 7. FIG. 7 is a schematic view illustrating an example of the room model 1000 having the blind 1 installed therein. FIG. 8 is a perspective view for explaining the daylighting function and the light shielding function. FIG. 9 is a view for explaining the daylighting function by the daylighting slat.

The room model 1000 is a model that, for example, assumes the use of the blind 1 in an office. More specifically, the room model 1000 illustrated in FIG. 7 assumes that external light LB from the outside enters, obliquely from above through a windowpane 1003, a room 1006 that is surrounded by a ceiling 1001, a floor 1002, a front wall 1004 equipped with the windowpane 1003, and a rear wall 1005 opposite to the front wall 1004. The blind 1 is disposed opposing the inner surface of the windowpane 1003.

In the room model 1000, the room 1006 has a height dimension H1 (i.e., a dimension from the ceiling 1001 to the floor 1002) of 2.7 m, the windowpane 1003 has a vertical dimension H2 of 1.8 m as measured from the ceiling 1001, the daylighting slat group 5 has a vertical dimension H3 of 0.6 m as measured from the ceiling 1001, and the room 1006 has a room depth dimension N (i.e., a dimension measured from the front wall 1004 to the rear wall 1005) of 16 m.

In the room model 1000, a person Ma is sitting on a chair in substantially the center of the room 1006, and a person Mb is standing on the floor 1002 in a rear end area of the room 1006. The person Ma sitting on the chair has an eye-level height Ha of 0.8 m as measured from the floor 1002 while the person Mb standing on the floor 1002 has an eye-level height Hb of 1.8 m as measured from the floor 1002.

The area where the person Ma and the person Mb in the room 1006 experience glare (such an area is hereinafter referred to as “glare area”) corresponds to the range of the eye-level height Ha and the eye-level height Hb of the person Ma and the person Mb in the room. Further, the area in the vicinity of the windowpane 1003 in the room 1006 is an area F where the external light LB is propagated mainly directly through the windowpane 1003. It is assumed that the area F corresponds to a distance of 1 m from the front wall 1004. Thus, the glare area G corresponds to a portion of the 0.8 m to 1.8 m range from the floor 1002 that extends from a position 1 m away from the front wall to the rear wall 1005 with the area F excluded.

In the daylighting slat group 5, as illustrated in FIGS. 8 and 9, external light LB having entered, obliquely from above, each of the daylighting slats 4 through one surface thereof is emitted obliquely upward from the other surface of the slat 4. More specifically, as illustrated in FIG. 9, the light having entered the daylighting slat 4 is reflected within the daylighting section 42 and then emitted from the second surface 41b of the base member 41 as light LB directed toward the ceiling 1001 (FIG. 7).

Note that although the compound pulley 9 is used as an element of the lifting/lowering operation section 17 in the embodiment, the compound pulley 9 may be replaced with a gear mechanism. Further, in the embodiment, an electronically controlled storage function may be provided as an element of the lifting/lowering operation section 17.

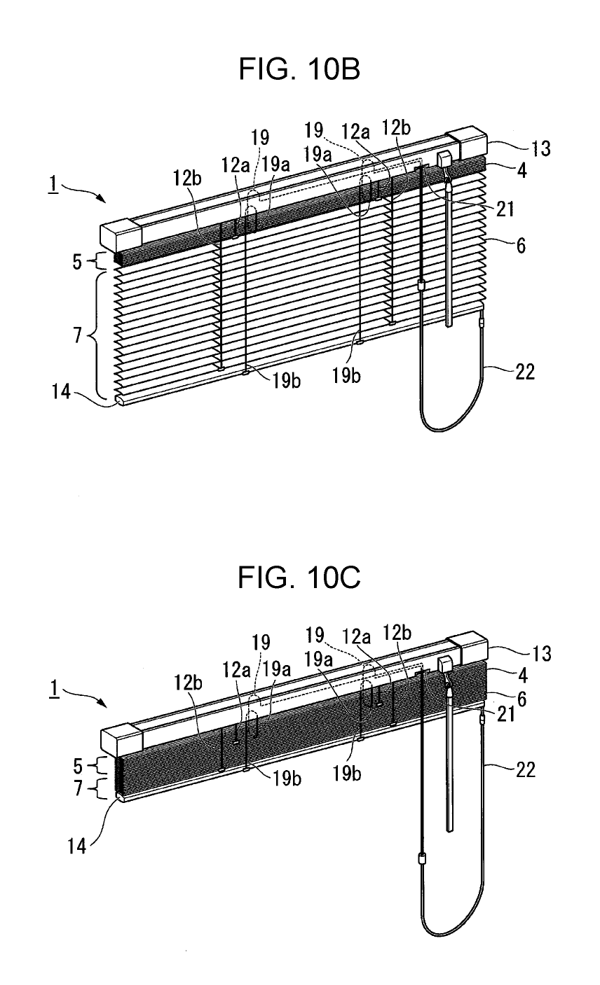

Various operations performed when the daylighting blind according to the first embodiment is in use are next described. FIGS. 10A to 10C are views illustrating various states of use of the daylighting blind.

When only the daylighting slat group 5 is to be stored from the state illustrated in FIG. 10A in which the entire blind 1 is in an extended position, the operating cord 22 is pulled a predetermined length. Thus, first, the first section 19a of the lifting/lowering cord 19 is pulled into the fixed box 13 while moving around the periphery of each of the pulleys 9A and 9B. Simultaneously, the plurality of daylighting slats 4 are raised together with the lowest daylighting slat 4 while the second lowest slat 4 and subsequent slats 4 sequentially overlapping the lowest daylighting slat 4. In this way, only the daylighting slat group 5 can be stored with the light-shielding slat group 7 remaining in the extended position, as illustrated in FIG. 10B. Note that as the daylighting slat group 5 collapses in the aforementioned manner, the light-shielding slat group 7 and the lifting/lowering bar 14 are raised in position. Both the lifting/lowering cords 19 are fixed by the stopper (not shown) provided inside the window section 21.

When the light-shielding slat group 7 is to be stored following the storage of the daylighting slat group 5, the operating cord 22 is pulled further with the daylighting slat group 5 remaining in the stored position. Thus, the second section 19b of the lifting/lowering cord 19 is pulled into the fixed box 13 while moving around the periphery of each of the pulleys 9A and 9B.

At this time, the light-shielding slats 6 are raised together with the lifting/lowering bar 14 while the lowest slat 6 and subsequent slats 6 sequentially overlapping the lifting/lowering bar 14. In this way, the light-shielding slat group 7 can be stored.

The daylighting function and light shielding function performed by the daylighting blind 1 according to the first embodiment are next described.

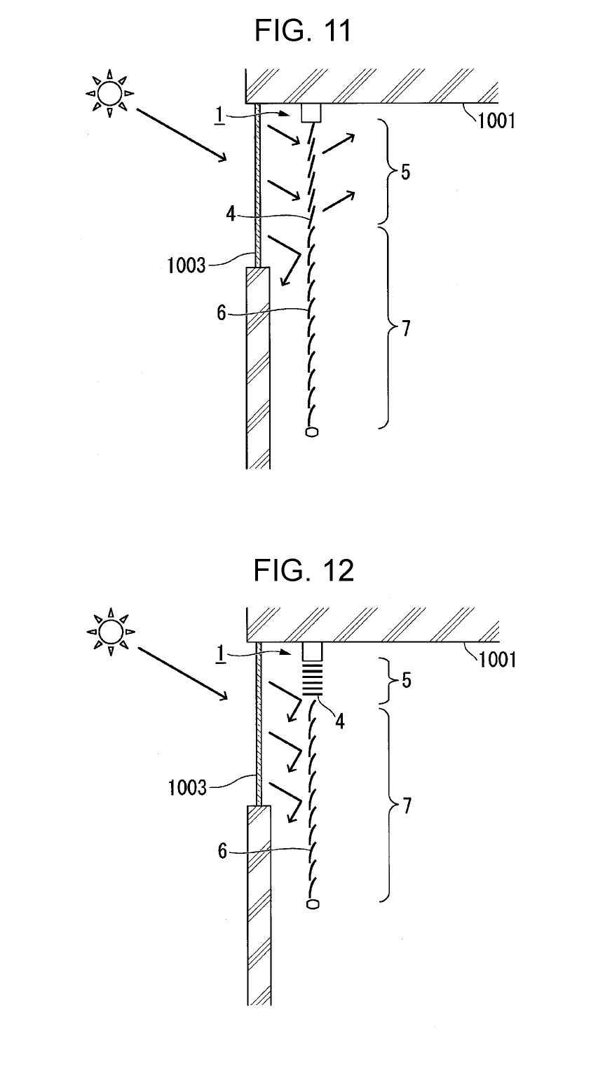

FIG. 11 is a view illustrating a daylighting state provided by the daylighting blind 1 according to the first embodiment.

FIG. 12 is a view illustrating a light shielding state provided by the daylighting slats according to the first embodiment.

Commonly known daylighting devices have only the daylighting function, and thus, to make a room a dark environment, a light shielding device equipped with the light shielding function has to be additionally provided.

In the fully extended position, as illustrated in FIG. 11, the blind 1 according to the embodiment daylights a part of incident light (sunlight) having entered the blind 1 through the window and blocks another part of the incident light. Of the incident light on the blind 1, the light having passed through the daylighting slat group 5 is emitted after its direction is changed approximately toward the ceiling. The light thus radiated to the room is scattered by the ceiling 1001, and thus the room can be made into a brightened environment without the use of artificial lighting. Further, of the incident light on the blind 1, the light incident on the light-shielding slat group 7 is reflected by or absorbed in each of the light-shielding slats 6, and blocked.

When only the light-shielding slat group 7 is extended with the daylighting slat group 5 remaining in the stored position to darken the room, as illustrated in FIG. 12, almost all of the light having passed through the windowpane 1003 is reflected by or absorbed in the light-shielding slat group 7 and blocked.

In the blind 1 according to the embodiment, which is a venetian blind including: the daylighting slat group 5 having the visible-light-transmitting daylighting function; and the light-shielding slat group 7 having the light shielding function based on light reflection and absorption, the daylighting slat group 5 and the light-shielding slat group 7 can be stored in a sequential manner, as described above. More specifically, the upper daylighting slat group 5 is stored first, and then the lower light-shielding slat group 7 is stored next. Because the blind 1 according to the embodiment is constructed to cause the daylighting slat group 5 to be stored first as described above, the light-shielding slat group 7 alone can be extended and used; that is, only the light shielding function can be selected.

Although there has been proposed in the related art a blind having a daylighting slat group 5 and a light-shielding slat group 7, such a proposed blind of the related art is not arranged to enable the upper daylighting slat group 5 to be stored first; instead, in the blind construction of the related art, the lower light-shielding slat group 7 is stored before the daylighting slat group 5 is stored. Therefore, even if such a blind equipped with both the daylighting function and the light shielding function is provided, a separate light shielding device, such as a curtain or a blind, has to be additionally provided.

By contrast to the aforementioned blind construction of the related art, the blind 1 according to the embodiment enables only the daylighting slat group 5 to be stored and extended independently, and thus, by installing only one blind 1 constructed in the above-described manner, the user can use any desired one of the daylighting function and the light shielding function while switching between the two functions as appropriate. In this way, the user is able to switch as desired between a daylighting environment and a dark environment without having to additionally install a light shielding device as in the related art.

Note that whereas the embodiment has been described above as including the compound pulley 9 as the lifting/lowering operation section 17 of the blind 1, the embodiment is not necessarily limited thereto. For example, the compound pulley 9 may be replaced with a gear mechanism.

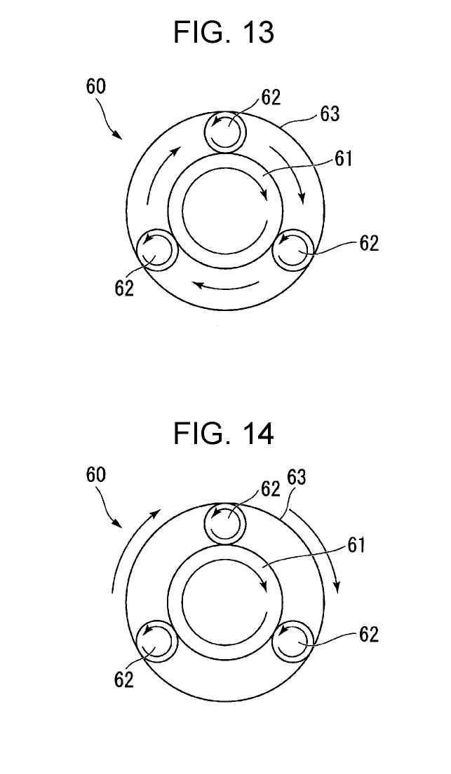

An example of such a gear mechanism is illustrated in FIGS. 13 and 14.

FIGS. 13 and 14 are schematic views illustrating a general construction of a planetary gear mechanism including planet gears and a sun gear, where FIG. 13 illustrates behavior of the planetary gear mechanism at the time of storing the daylighting slat group 5 and FIG. 14 illustrates behavior of the planetary gear mechanism at the time of storing the daylighting slat group.

A planetary gear mechanism 60 illustrated in FIGS. 13 and 14 includes: a sun gear 61; planet gears 62 disposed around and meshing with the sun gear 61; and a ring gear 63 meshing with the planet gears 62 and provided coaxially with the sun gear 61. This planetary gear mechanism 60 is housed within the above-mentioned fixed box 13. A daylighting-slat lifting/lowering cord (not shown) is connected to a rotation shaft of the sun gear 61. A light-shielding-slat lifting/lowering cord (not shown) is connected to a rotation shaft of the ring gear 63.

The sun gear 61 is rotated by the daylighting-slat lifting/lowering cord being pulled by the user. At a beginning stage of rotation of the sun gear 61, the planet gears 62 revolve around the sun gear 61 while rotating, such that the daylighting slat group 5 is rolled up. Upon completion of the rolling-up of the daylighting slat group 5, each of the planet gears 62 is locked so as to only rotate. Such rotation of the planet gears 62 causes rotation of the ring gear 63 disposed as the outermost gear (see FIG. 14). Such rotation of the ring gear 63 causes the light-shielding slat group 7 to be rolled up.

### Second Embodiment

Next, a description will be given of a daylighting blind according to a second embodiment of the invention.

The daylighting blind according to the second embodiment to be described hereinbelow has a substantially similar fundamental construction to the above-described first embodiment, but differs from the first embodiment in terms of the construction of the lifting/lowering operation section (double-control construction). Thus, in the following description, structural features of the second embodiment different from the first embodiment will be described in detail with a description of similar structural features to the first embodiment omitted. Further, in individual figures to be used for the description of the second embodiment, the same elements as in FIGS. 1 to 12 are denoted with the same reference numerals as in FIGS. 1 to 12.

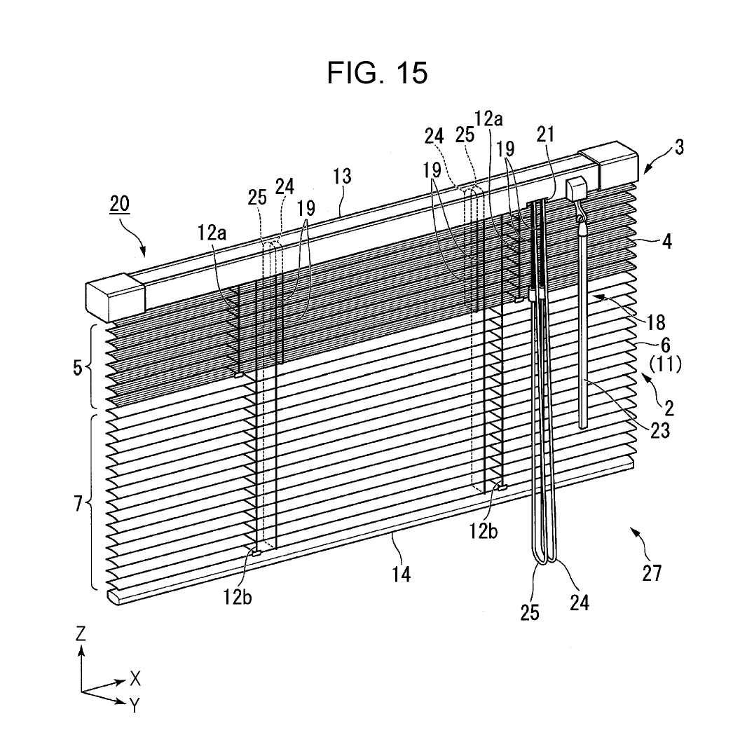

FIG. 15 is a perspective view illustrating an outer appearance of the daylighting blind according to the second embodiment.

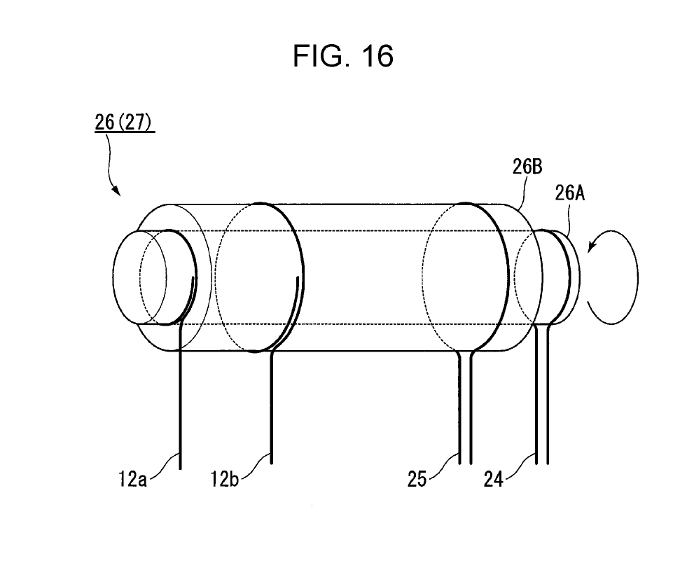

FIG. 16 is a view illustrating a general construction of the lifting/lowering operation section (roll-up mechanism) in the second embodiment.

The blind 20 according to the second embodiment includes a lifting/lowering operation section 27 capable of performing storage control of the daylighting slat group 5 and the light-shielding slat group 7 independently of each other.

The lifting/lowering operation section 27 includes two systems of lifting/lowering cords (lifting/lowering members) 24 and 25, the above-mentioned two systems of ladder cords 12a and 12b, and a roll-up mechanism 26.

One of the two systems of lifting/lowering cords 24 and 25 is a system of daylighting-slat lifting/lowering cords 24, and the other is a system of light-shielding-slat lifting/lowering cords 25. The two systems of lifting/lowering cords 24 and 25 are provided for the daylighting slat group 5 and the light-shielding slat group 7, with one lifting/lowering cord for each slat group.

Further, a plurality of the ladder chords 12a and 12b are provided for each of the slat groups 5 and 7 as in the previously described embodiment.

The roll-up mechanism 26 includes a first rotation shaft (rotation shaft) 26A and a second rotation shaft (rotation shaft) 26B differing from each other in diameter. The larger-diameter second rotation shaft 26B is disposed outside the smaller-diameter first rotation shaft 26A in concentric relation thereto. The daylighting-slat lifting/lowering cord 24 and the daylighting-slat ladder cord 12a are connected to the first rotation shaft 26A disposed inside the second rotation shaft 26B. The light-shielding-slat lifting/lowering cord 25 and the light-shielding-slat ladder cord 12b are connected to the outer second rotation shaft.

Note that the connecting combinations among the rotation shafts 26A and 26B, the lifting/lowering cords 24 and 25, and the ladder cords 12a and 12b are not necessarily limited to the aforementioned combination and may be modified as appropriate.

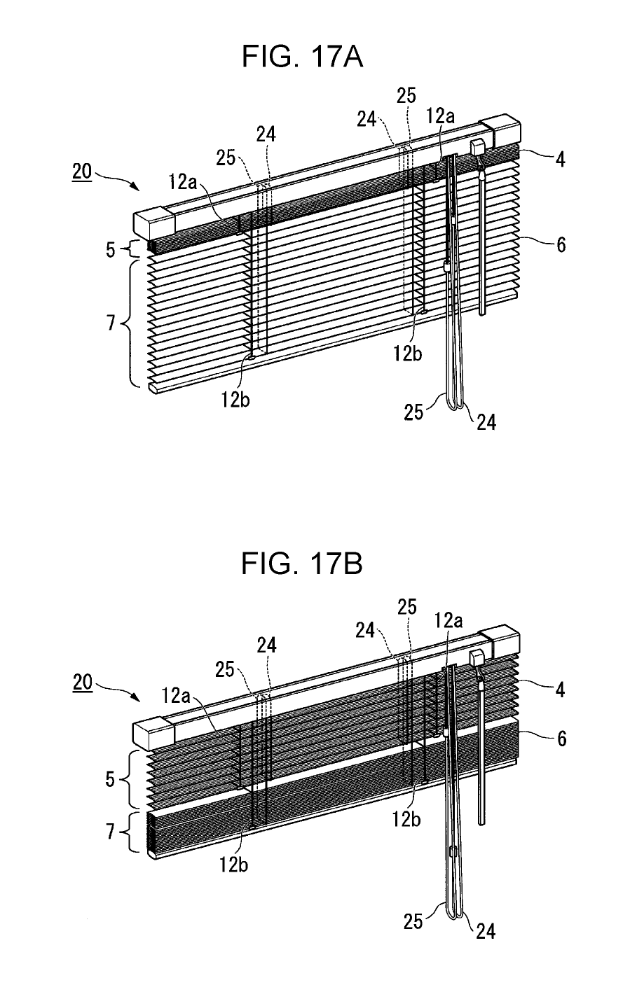

FIG. 17A illustrates a state where only the daylighting slat group of the blind according to the second embodiment is held in the stored position, and FIG. 17B illustrates a state where only the light-shielding slat group is held in the stored position.

In the blind 20 according to the second embodiment, the above-mentioned first rotation shaft 26A rotates by the daylighting-slat lifting/lowering cord 24 being pulled by the user, so that the daylighting slat group 5 is rolled up (FIG. 17B). The above-mentioned second rotation shaft 26B is rotated by the light-shielding-slat lifting/lowering cord 25 being pulled by the user, so that the light-shielding slat group 7 is rolled up (FIG. 17B) separately from the daylighting slat group 5. With the slat-lifting rotation shafts 26A and 26B provided for the slat groups 5 and 7 as described above, the embodiment enables the slat groups 5 and 7 to be controlled independently of each other.

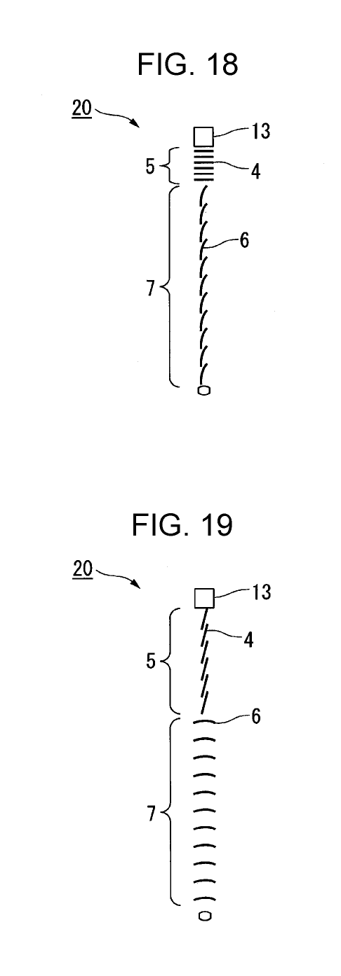

FIG. 18 is a view illustrating a light shielding state of the blind according to the second embodiment. FIG. 19 is a view illustrating a daylighting state of the blind according to the second embodiment.

By the daylighting slat group 5 being controlled independently, as illustrated in FIGS. 18 and 19, the user can select any one of various patterns of daylight use including not only daylighting and light shielding conditions but also angle adjustment of the slats 2.

The states of use of the blind according to the second embodiment are next described in detail.

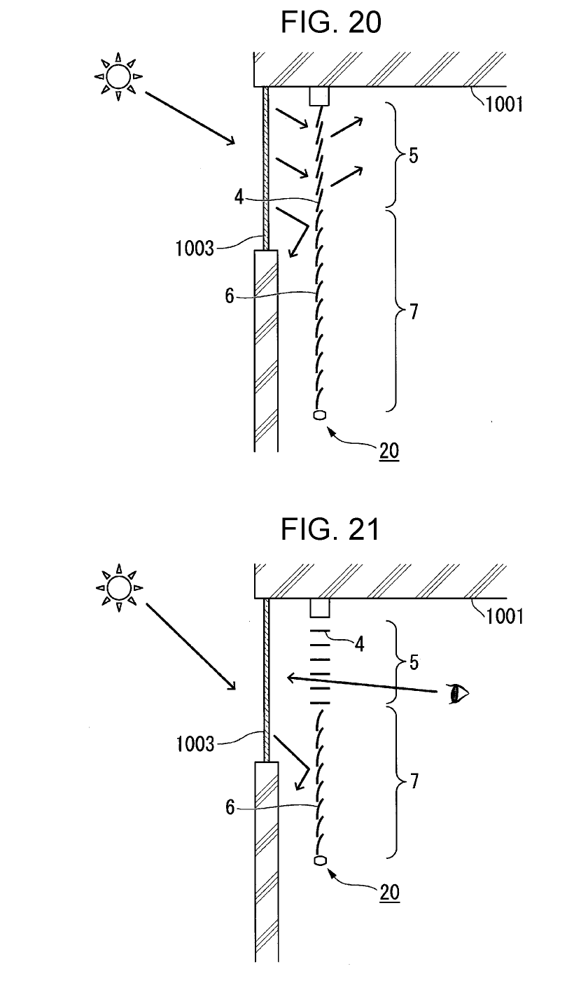

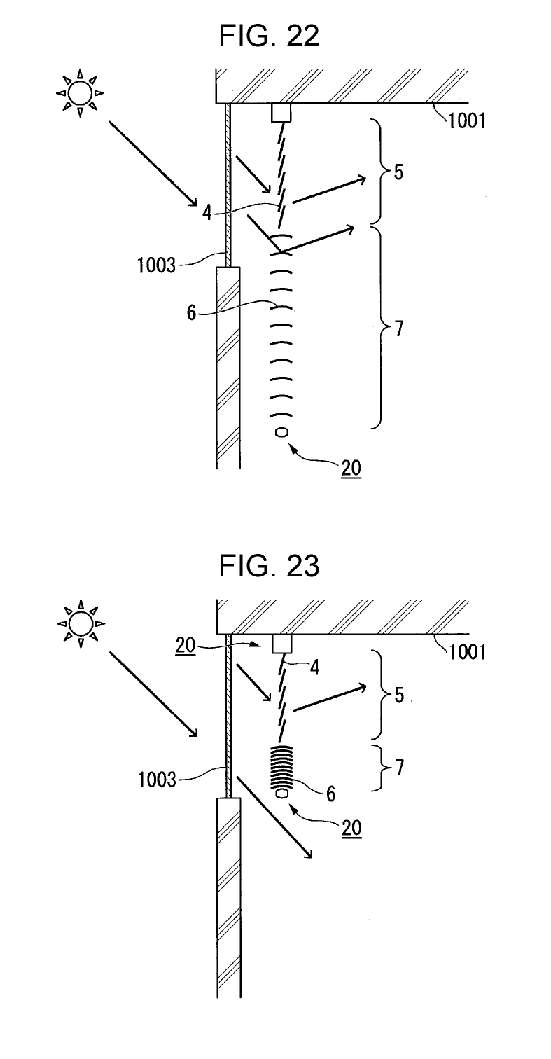

FIG. 20 is a view illustrating a daylighting state of the blind according to the second embodiment. FIG. 21 is a view illustrating a state where the daylighting slats of the blind according to the second embodiment are oriented in a horizontal direction. FIG. 22 is a view illustrating a state where the light-shielding slats of the blind according to the second embodiment are oriented in a horizontal direction. FIG. 23 is a view illustrating a state where the light-shielding slat group of the blind according to the second embodiment is held in the stored position.

When a bright environment is to be ensured in a building having an extended roof, for example, it is possible to allow bright light to enter the room by adjusting a tilt angle of the daylighting slats 4 in accordance with latitude and orientation of the window, sun elevation, and the like, as illustrated in FIG. 20. On the other hand, by closing the light-shielding slats 6, it is possible to block light that would expose a person in the room to experience glare.

Further, by adjusting the individual upper daylighting slats 4 to the horizontal orientation when the sun elevation is high, it is possible to secure good viewing from the room while blocking direct sunlight, as illustrated in FIG. 21.

Furthermore, in a weak sunlight environment, it is possible to enhance the capability of directing sunlight toward the ceiling 1001 by adjusting the individual light-shielding slats 6 to the horizontal orientation, as illustrated in FIG. 22.

Furthermore, in an environment where people can withstand the glare of sunlight, it is possible to use the blind in such a manner as to further increase the amount of sunlight allowed to enter while the slats other than the light-shielding slat group 7 are held in the stored position as illustrated in FIG. 23.

Note that although in the second embodiment the lifting/lowering cords 24 and 25 disposed outside of the blind 1 so as to be operable by the user, another suitable mechanism, such as an electronically controlled mechanism, may be employed in place of such cords 24 and 25. Further, the second embodiment may alternatively be constructed to control only the daylighting slat group 5 independently, rather than constructed to control each of the slat groups 5 and 7 independently of the other.

### Third Embodiment

Next, a description will be given of a daylighting blind according to a third embodiment of the invention.

The daylighting blind according to the third embodiment to be described hereinbelow is substantially similar in fundamental construction to the above-described first embodiment, but differs from the first embodiment in terms of the construction of the lifting/lowering operation section (triple-control construction). Thus, in the following description, structural features of the third embodiment different from the previously described embodiments will be described in detail with a description of structural features similar to the previously described embodiments omitted. Further, in individual figures to be used for the description of the third embodiment, the same elements as in FIGS. 1 to 12 are denoted with the same reference numerals as in FIGS. 1 to 12.

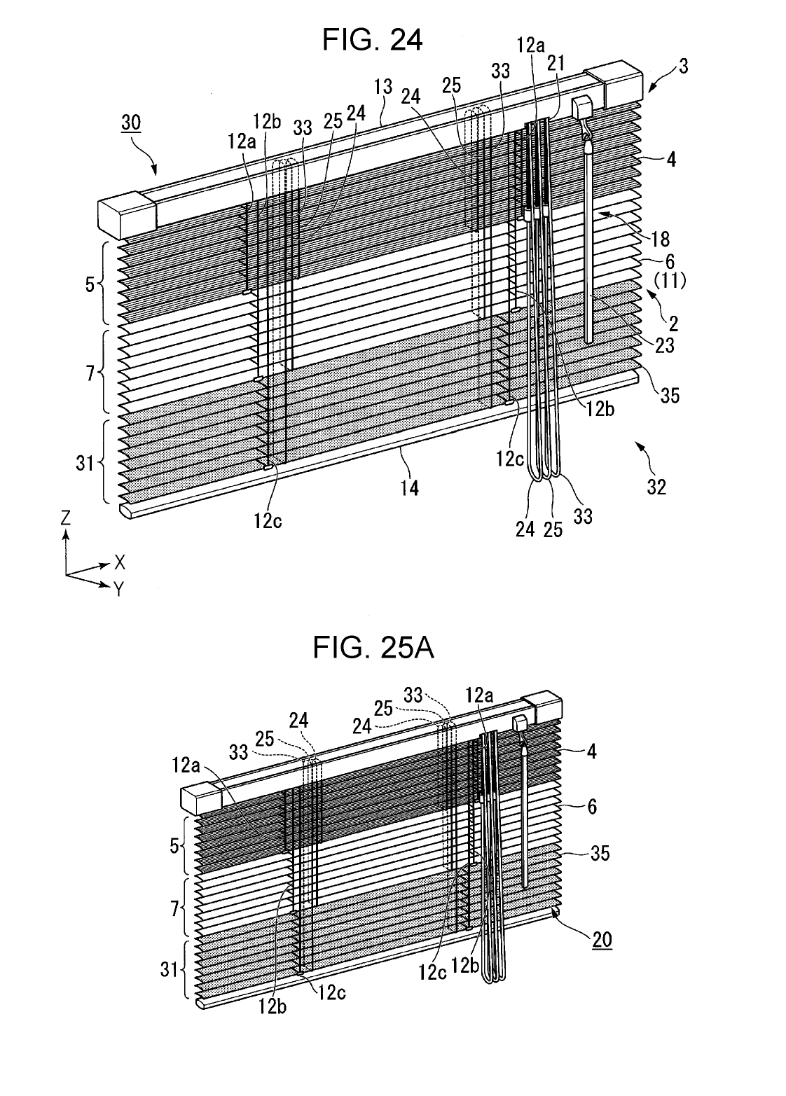

FIG. 24 is a perspective view illustrating an outer appearance of the daylighting blind according to the third embodiment.

The blind 30 according to the third embodiment includes: the daylighting slat group 5; the light-shielding slat group 7; a diffusing slat group 31; and a lifting/lowering operation section 32 capable of performing storage control of the slat groups 5, 7, and 31 independently of one another. A plurality of diffusing slats 35 composing the diffusing slat group 31 each has a diffusing function capable of diffusing visible light therethrough. For example, a light diffusing sheet or the like for diffusing incident light may be secured to one surface of each of the diffusing slats 35. Further, each of the diffusing slats 35 may have an anisotropic property in light diffusing directions such that high diffusion is achievable in the horizontal direction.

The lifting/lowering operation section 32 includes: three systems of lifting/lowering cords 24, 25, and 33; three systems of ladder cords 12a, 12b and 12c; and a roll-up mechanism (not shown).

In the blind 30 according to the third embodiment, the daylighting slat group 5 is disposed in an upper portion of the blind 30, the light-shielding slat group 7 is disposed in a vertically intermediate portion of the blind 30, and the diffusing slat group 31 is disposed in a lower portion of the blind 30. The diffusing slat group 31 is preferably positioned lower than the eye level of any person in the room. A plurality of ladder cords 34 for adjusting the tilt of the individual diffusing slats 35 and diffusing-slat lifting/lowering cords 33 for moving the individual diffusing slats 35 to a stored position are provided for the diffusing slat group 31.

The roll-up mechanism (not shown) includes three shaft sections differing from one another in diameter, and the three systems of lifting/lowering cords 24, 25, and 33 and the three systems of ladder cords 12a, 12b, and 12c are connected to corresponding shaft sections. The three shaft sections are provided in concentric relation to one another, and the connecting combinations among the cords are set as appropriate.

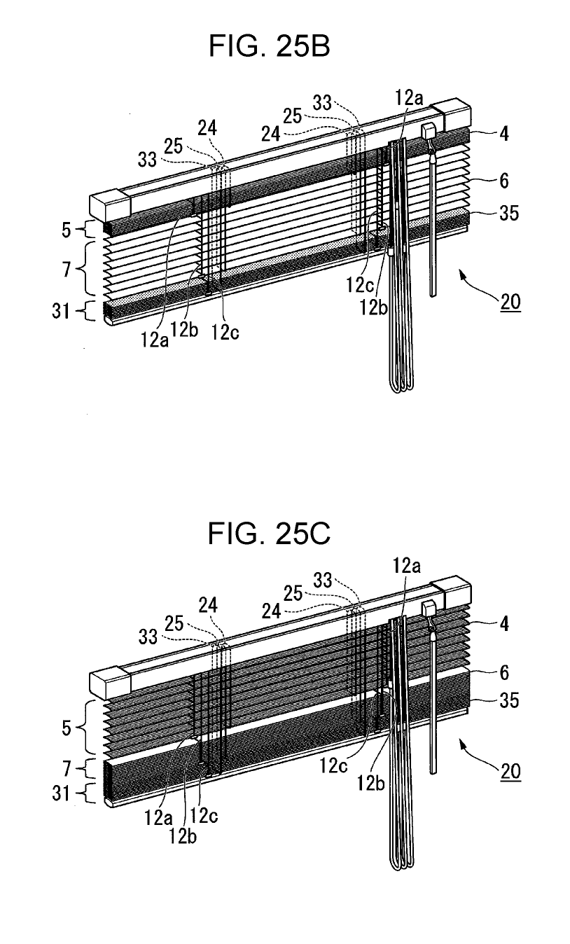

FIG. 25A is a view illustrating a state where only the diffusing slat group of the blind according to the third embodiment is held in the stored position, FIG. 25B is a view illustrating a state where the daylighting slat group and the diffusing slat group are held in the stored position, and FIG. 25C is a view illustrating a state where the light-shielding slat group and the diffusing slat group are held in the stored position.

In the blind 30 according to the third embodiment, the shaft section having the diffusing-slat lifting/lowering cords 33 connected thereto is rotated by the user pulling the diffusing-slat lifting/lowering cords 33, such that the diffusing slat group 31 is rolled up (FIG. 25A). In a strong sunlight environment, the diffusing slat group 31 may remain in the stored position because a sufficiently bright environment is achievable by using the daylighting slat group 5.

Further, FIG. 25B illustrates a state of the blind where the daylighting slat group 5 is held in the rolled-up position. Because the blind is placed in the light shielding state in this manner, a dark environment can be obtained.

Furthermore, in an environment where people in the room can withstand the glare of sunlight, it is also possible to use the blind 30 with only the daylighting slat group 5 extended and the light-shielding slat group 7 and the diffusing slat group 7 held in the rolled-up position as illustrated in FIG. 25C.

The following describes the daylighting function, light shielding function, and diffusing function performed by the blind according to the third embodiment.

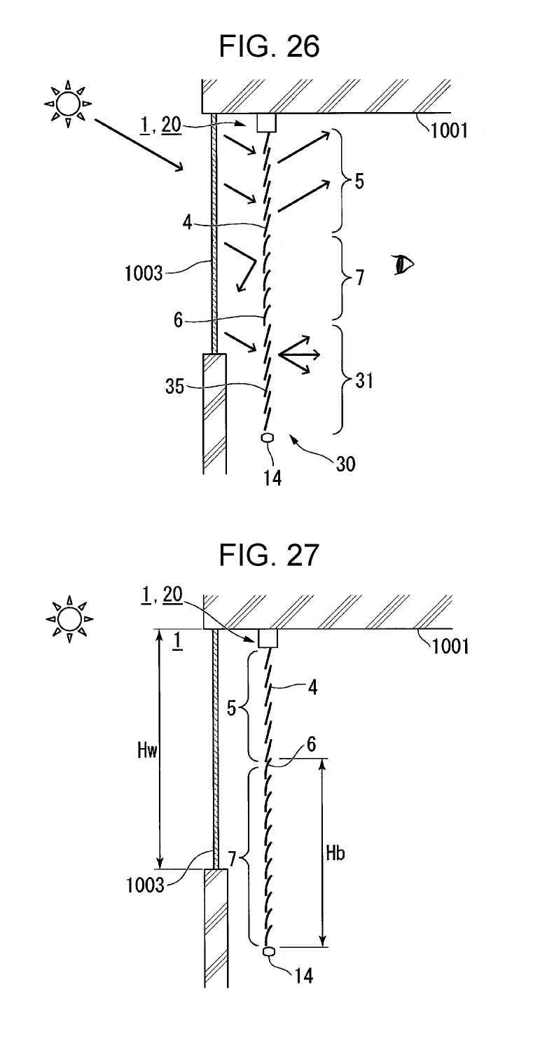

FIG. 26 is a view illustrating each of the functions performed by the blind according to the third embodiment.

With the blind 30 according to the third embodiment, light emitted from the daylighting slat group 5, having the daylighting function, is scattered by the ceiling and thus can illuminate the space in the room to thereby make the room a bright environment, as illustrated in FIG. 26. In contrast, light emitted from the diffusing slat group 31, having the light diffusing function, can directly illuminate the room.

However, the light emitted from the diffusing slat group 31 may sometimes enter the eye level of a person in the room and expose the person to glare, depending on the position of the sun. In such a case, by driving the individual slat groups 5, 7, and 31 independently of one another, the blind 30 can place any desired one or more of the slat groups in the stored position and thereby provide a good daylight-using space where no person in the space would be exposed to glare.

### Fourth Embodiment

Next, a description will be given of a daylighting blind according to a fourth embodiment of the invention.

The daylighting blind according to the fourth embodiment to be described hereinbelow is substantially similar in fundamental construction to the above-described first embodiment. Here, a length dimension of the blind, among other things, will be described. In the following description, a feature of the fourth embodiment different from the previously described embodiments will be described in detail with a description of structural features similar to the previously described embodiments omitted. Further, in individual figures to be used for the description of the fourth embodiment, the same elements as in FIGS. 1 to 12 are denoted with the same reference numerals as in FIGS. 1 to 12.

Note that the embodiment to be set forth below is applicable to any one of the blinds according to the above-described first to third embodiments.

FIG. 27 is a sectional view illustrating the length relationship between the blind according to the fourth embodiment and the window.

The blind 40 according to the fourth embodiment has a vertical length Hb of the light-shielding slat group 7 when extended with the plurality of light-shielding slats 6 oriented in the vertical direction, for example, in each of the blinds 1 and 20 according to the first and second embodiments as illustrated in FIG. 27, greater than a vertical length Hw of the windowpane 1003.

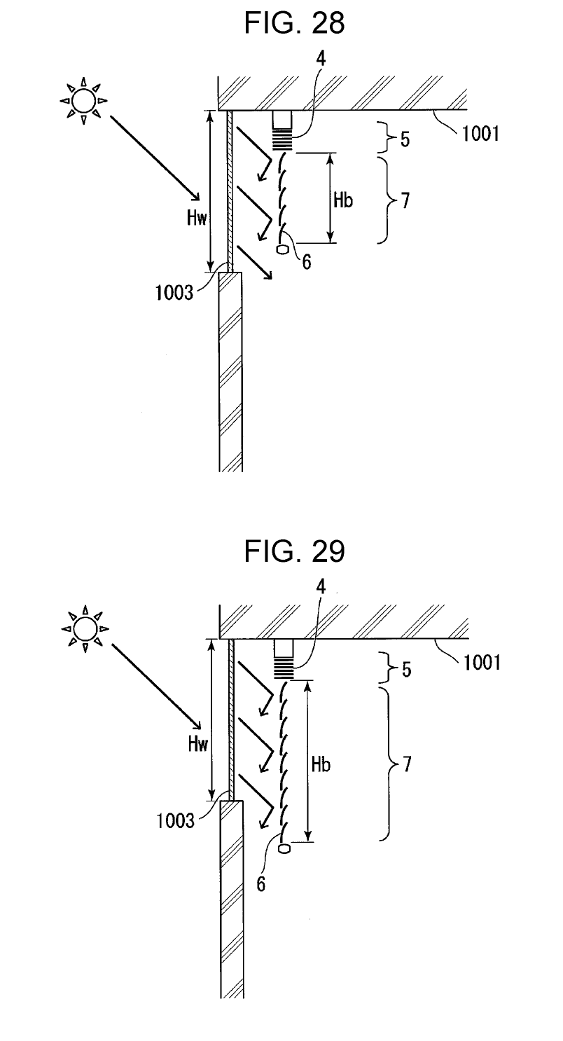

FIG. 28 is a view illustrating a state of use of the blind where the vertical length of the light-shielding slat group is smaller than the vertical length of the windowpane. FIG. 29 is a view illustrating a state of use of the blind according to the fourth embodiment.

In the case where the vertical length Hb of the light-shielding slat group 7 is smaller than the vertical length Hw of the windowpane 1003 (Hb≤Hw) as illustrated in FIG. 28, external light entering through the window is not completely blocked.

On the other hand, the blind according to the fourth embodiment, where the vertical length Hb of the light-shielding slat group 7 is greater than the vertical length Hw of the windowpane 1003 (Hb>Hw) as illustrated in FIG. 29, can completely block external light entering through the window in the same manner as the light-shielding-only blind according to the related art and thereby darken the room as desired.

Note that whereas the length feature has been described above in relation to the blinds 1 and 20 according to the first and second embodiments, it is also applicable to the light-shielding slat group 7 of the blind 30 according to the third embodiment.

### [Daylighting Device]

Next, a description will be given of a daylighting device according to an aspect of the invention.

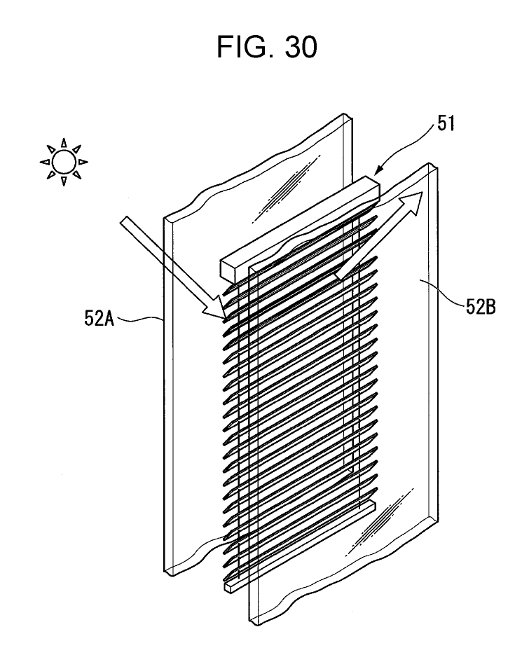

FIG. 30 is a view schematically illustrating the daylighting device according to the aspect of the invention.

A daylighting device 50 according to an embodiment includes: a blind 51 according to any one of the first to fourth embodiments; and a pair of sheet glasses 52A and 52B.

The blind 51 is disposed between the first sheet glass (first substrate) 52A having a light transmitting property and the second sheet glass (second substrate) 52B having a light transmitting property and disposed opposing to the first sheet glass. These sheet glasses 52A and 52B are disposed spaced from the blind 51 so as not to come into contact with the blind 51.

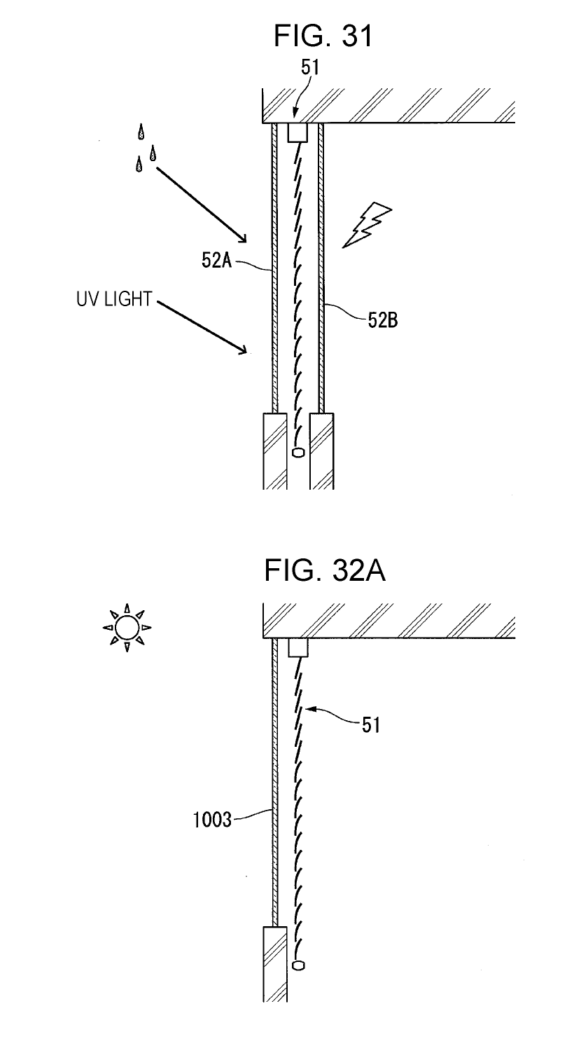

FIG. 31 is a view illustrating a state of use of the daylighting device according to the aspect of the invention.

As illustrated in FIG. 31, the daylighting device, which employs a multilayered glass structure having the blind 51 disposed between the pair of sheet glasses 52A and 52B, can protect the blind 51 from external factors that would cause deformation and a property change of the blind 51. Thus, with such a daylighting device, it is possible to maintain for a long time optical functions of the individual elements while preventing deterioration of the above-mentioned daylighting sheets (daylighting surfaces) provided on the individual daylighting slats 4, light diffusing surfaces, and the like.

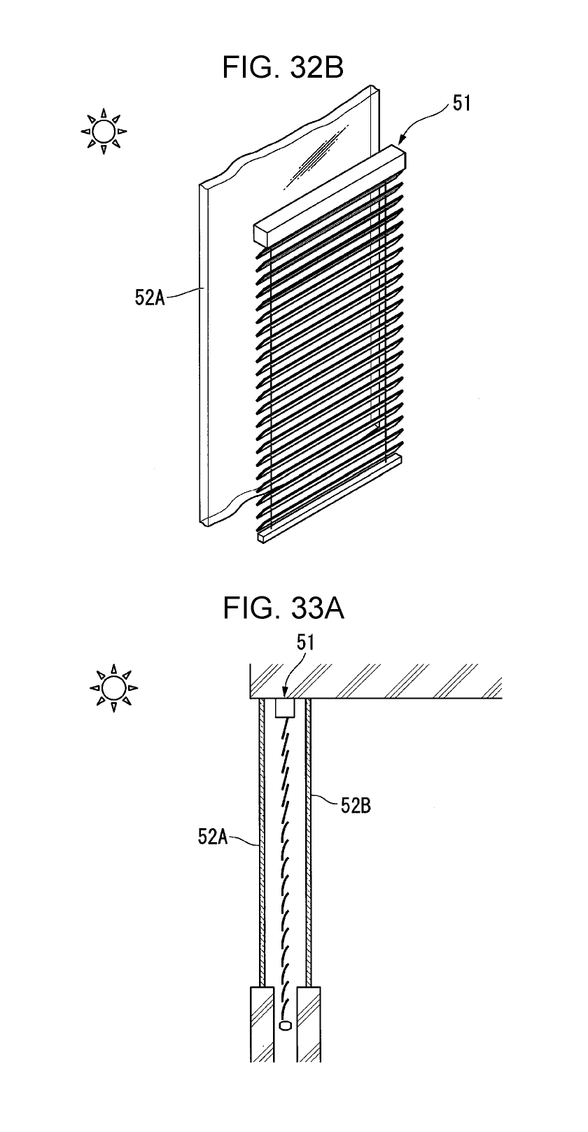

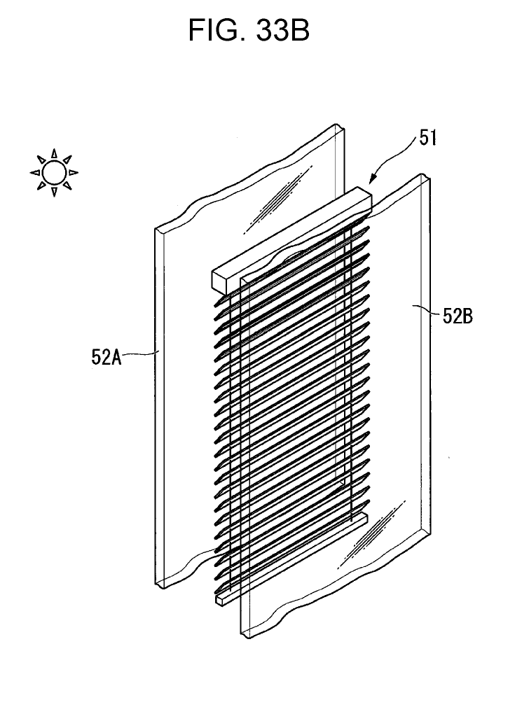

Further, between the case in which the blind 51 is disposed in the room side of the windowpane 1003 as illustrated in FIGS. 32A and 32B and the case in which the blind 51 is disposed between the layers of glass as illustrated in FIGS. 33A and 33B, there is little difference in appearance due to the presence or absence of the installed blind 51.

Note that the construction of the daylighting device of the invention is not necessarily limited to the aforementioned construction. For example, the multilayered glass structure including the blind 51 and the pair of sheet glasses 52A and 52B may be supported by a frame that is not shown.

### [Daylighting System]

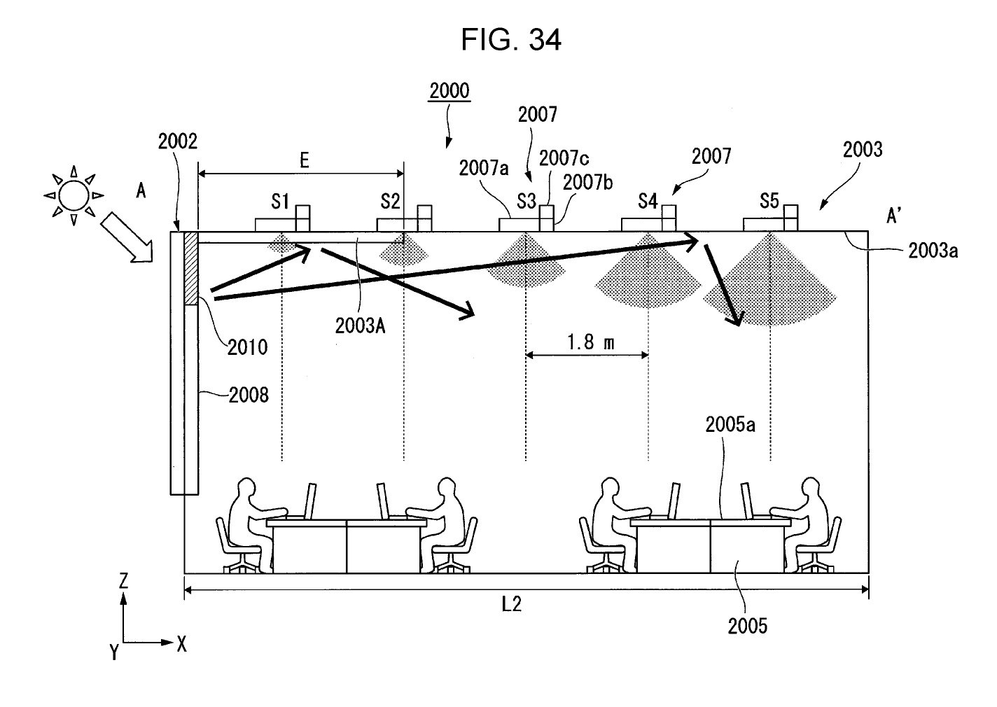

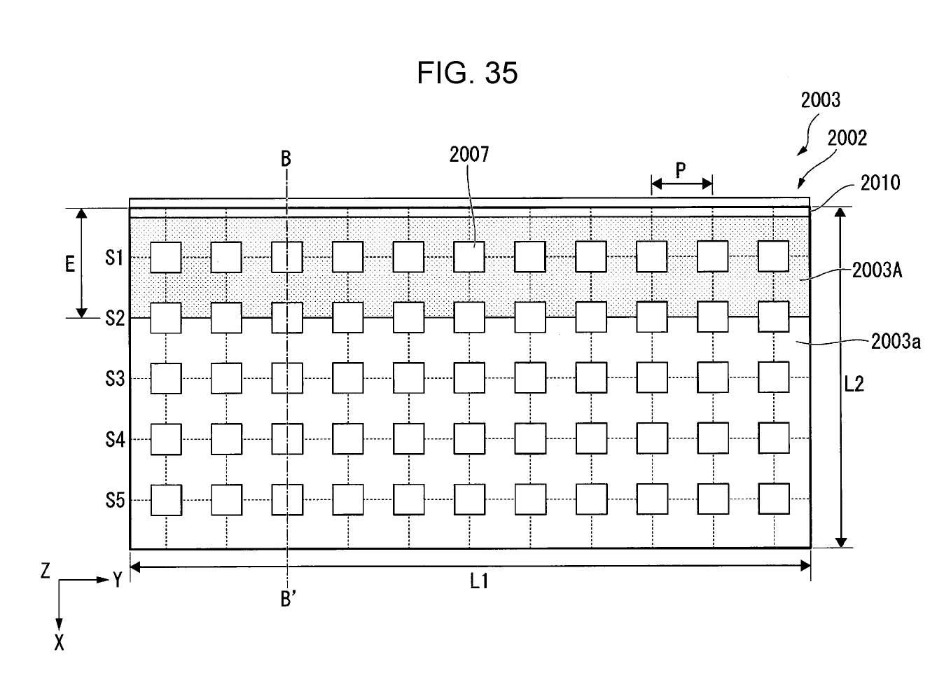

FIG. 34 is a sectional view, taken along line B-B′ of FIG. 35, which illustrates a room model 2000 equipped with a daylighting device and a lighting control system. FIG. 35 is a plan view illustrating the ceiling of the room model 2000.

In the room model 2000, material forming the ceiling 2003a of a room 2003 into which external light is introduced may have high light reflectivity. As illustrated in FIGS. 34 and 35, light-reflective ceiling material 2003A is provided on the ceiling 2003a of the room 2003. The light-reflective ceiling material 2003A is designed to promote introduction of external light via the daylighting device 2010, installed on a window 2002, deep into the rear of the room, and the ceiling material 2003A is provided on a region of the ceiling 2003a near the window. More specifically, the light-reflective ceiling material 2003A is provided on a predetermined region E of the ceiling 2003a (i.e., a ceiling region which extends about 3 m from the window 2002).

The light-reflective ceiling material 2003A functions to efficiently direct the external light, introduced into the room via the window 2002 having the daylighting device 2010 (e.g., the blind according to any one of the above-described embodiments, or the above-described daylighting device) installed thereon, deep into the rear of the room. The external light introduced from the daylighting device 2010 toward the ceiling 2003a of the room is reflected by the light-reflective ceiling material 2003A, such that it changes its propagation direction to illuminate an upper surface 2005a of a desk 2005 placed in a rear portion of the room. In this manner, the light introduced from outside can exert the effect of brightening the upper surface 2005a of the desk 2005.

The light-reflective ceiling material 2003A may be either diffuse reflective or specular reflective. However, in order to achieve both the effect of brightening the upper surface 2005a of the desk 2005 placed in the rear portion of the room and the effect of suppressing glare that causes discomfort to a person in the room, it is preferable that the material 2003A have an appropriate mixture of the two above-mentioned reflective properties.

Although most of the light introduced by the daylighting device 2010 into the room propagates to a portion of the ceiling near the window 2002, the amount of light near the window 2002 tends to be sufficient in many cases. Thus, by using the aforementioned light-reflective ceiling material 2003A in conjunction with the other arrangements, it is possible to distribute some of the light, having reached the ceiling portion (region E) near the window, to a rear portion of the room where the amount of light is low compared with that near the window.

The light-reflective ceiling material 2003A can be made, for example, by embossing a metal plate with bumps and dips each having a size of about several tens of microns or by vapor-depositing a thin film of metal such as aluminum on the surface of a resin substrate having similar bumps and dips formed thereon. Alternatively, the bumps and dips may be formed by embossing in such a manner so as to have curved surfaces at greater pitches.

Further, by changing as appropriate the shape of the embossed bumps and dips to be formed on the light-reflective ceiling material 2003A, it is possible control light distribution characteristics and light distribution in the room. In a case where the embossing is performed to form stripe-shaped bumps and dips extending toward the rear of the room, for example, the light reflected by the light-reflective ceiling material 2003A spreads out in a left-right direction of the window 2002 (i.e., a direction intersecting the longitudinal direction of the embossed bumps and dips). In a case where the window 2002 of the room 2003 is limited in terms of size and orientation, it is possible to use such a characteristic of the light to diffuse the light in the horizontal direction and reflect the light toward the rear of the room by using the ceiling material 2003A.

The daylighting device 2010 is employed as part of the lighting control system of the room 2003. The lighting control system is constructed of elements for the entire room that include, for example, the daylighting device 2010, a plurality of room lighting devices 2007 and the light-reflective ceiling material 2003A provided on the ceiling 2003a.

In the room 2003, the room lighting devices 2007 are disposed in a lattice configuration extending in the left-right direction (Y direction) of the window 2002 and in a depth direction (X direction) of the room. These room lighting devices 2007 constitute a lighting system for the entire room 2003 in conjunction with the daylighting device 2010.

FIGS. 34 and 35 illustrate the ceiling 2003a of an office where, for example, a length L1, in the left-right direction (Y direction) of the window 2002, of the window 2002 is 18 m and a length L2, in the depth direction (Y direction) of the room 2003 is 9 m. Here, the room lighting devices 2007 are disposed in a lattice configuration at intervals P of 1.8 m in both the lateral direction (Y direction) and depth direction (X direction) of the ceiling 2003a.

More specifically, 50 such room lighting devices 2007 are arranged in an 11-column (Y direction)×5-row (X direction) configuration.

Each of the room lighting devices 2007 includes a piece of room lighting equipment 2007a, a brightness detection section 2007b, and a control section 2007c, and the brightness detection section 2007b and the control section 2007c are integrated with the room lighting equipment 2007a.

Each of the room lighting devices 2007 may include a plurality of pieces of room lighting equipment 2007a and a plurality of the brightness detection sections 2007b. Note, however, that one brightness detection section 2007b is provided for each of the pieces of room lighting equipment 2007a. The brightness detection section 2007b receives light reflected on an illuminated surface, illuminated by the room lighting equipment 2007a, to detect an illuminance on the illuminated surface. In the illustrated example, the brightness detection section 2007b detects an illuminance on the upper surface 2005a of the desk 2005 placed in the room.

The control sections 2007c, each of which is provided in a corresponding one of the room lighting devices 2007, are connected with one another. The room lighting devices 2007 perform, by using the interconnected control sections 2007b, feedback control for adjusting light output of an LED lamp of the room lighting device 2007 in such a manner that the illuminance on the upper surface 2005a of the desk 2005 detected by the corresponding brightness detection section 2007b equals a predetermined target illuminance LO (e.g., average illuminance of 750 1×).

With the daylighting system according to the embodiment, it is possible to achieve a predetermined illuminance, regardless of the time of the day and the position of the room 2003, by associating light allowed to enter via the daylighting device 2010, which changes in accordance with sunlight, and with the room lighting device 2007, so that both a comfortable environment and efficient energy saving are achieved.

Further, because the daylighting device 2010 alone can fully block light passing through the window, it is possible to achieve a dark environment as appropriate while eliminating the need for separately providing an additional blind or curtain.

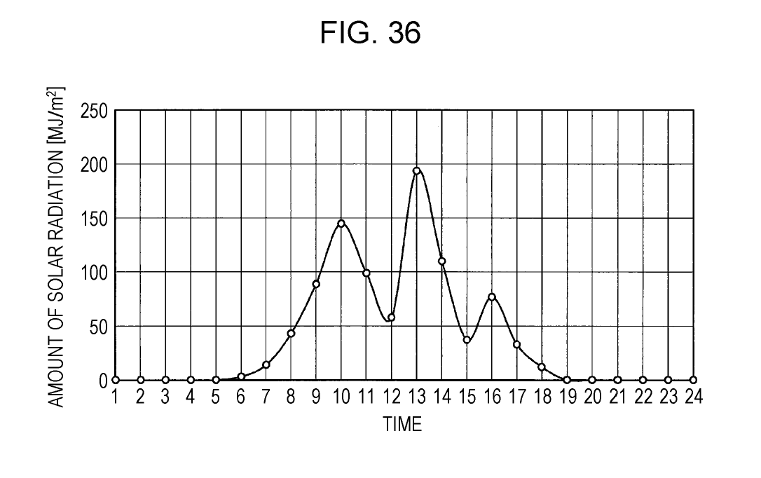

FIG. 36 is a graph illustrating the amount of solar radiation in Tokyo on Spring Equinox Day. In FIG. 36, the vertical axis represents the amount of solar radiation [MJ/m²], and the horizontal axis represents the time of the day. Note that FIG. 36 is an example of data stored in the “Solar Radiation Database” of the New Energy and Industrial Technology Development Organization (NEDO).

As illustrated in FIG. 36, the amount of solar radiation in Tokyo on Spring Equinox Day varies greatly with the time of the day, and distribution peaks exist at about 10 AM, 1 PM, and 4 PM.

Further, the variation in the amount of solar radiation is substantially symmetrical about each of the distribution peaks.

The amount of solar radiation starts to increase as the sun rises and becomes 150 [MJ/m²] at 10 AM. Then, the amount of solar radiation starts to gradually decrease to become 55 [MJ/m²] at 12 PM, rapidly increases again, and reaches close to 200 [MJ/m²] at 1 PM, which is the highest amount of the day. Then, the amount of solar radiation starts to decrease again and increases slightly at 4 PM.

Thus, with the daylighting device 2010 according to an aspect of the invention, it is possible to achieve a predetermined illuminance, regardless of the time of the day and the positions of the room and window, by associating the amount of solar radiation of the day, i.e., the light allowed to enter via the daylighting device 2010 which varies with the change in solar elevation, and the lighting by the room lighting device 2007. As a result, both a comfortable room environment and efficient energy saving are achieved.

As described above, even when the amount of light incident on the daylighting device 2010 varies depending on the season, time of the day, weather, etc., embodiments of the invention can provide, through combined use of the daylighting device 2010 and the lighting control system (room lighting device 2007), a comfortable room environment by adjusting the lighting in accordance with information from the brightness detection section 2007b while receiving sunlight and supplementing an insufficient illuminance by using the room lighting equipment 2007a. As a result, across the entire room, a desk-upper-surface illuminance sufficient for working is secured. Thus, an even more stable bright light environment is realized without being affected by seasons or the weather.

Preferred embodiments of the invention have been described above with reference to the accompanying drawings, however, it goes without saying that the invention is not limited to such embodiments. It should be apparent to persons skilled in the art that various modifications or alterations of the embodiments are possible within the scope of the technical ideas recited in the appended claims, and that such various modifications or alterations too fall within the technical scope of the invention.

### INDUSTRIAL APPLICABILITY

Several aspects of the invention are applicable to daylighting blinds, daylighting devices, lighting systems, etc. where it is necessary to cause the daylighting function and the light shielding function to be performed independently of each other.

### REFERENCE SIGNS LIST

1, 20, 30, 40, 51 blind (daylighting device), 2 slat, 3 support mechanism, 4 daylighting slat, 5 daylighting slat group, 6 light-shielding slat, 7 light-shielding slat group 9, 9A pulley, 13 fixed box (storage box), 19, 24 lifting/lowering cord (lifting/lowering member), 26 mechanism, 26A first rotation shaft (rotation shaft), 26B second rotation shaft (rotation shaft), 31 diffusing slat group, 35 diffusing slat, 50, 2010 daylighting device 1006 room, 2002 window, 2007b detection section 2007c control section, Hb, Hw, L, L1, L2 length, LB light

1. A daylighting blind comprising:
a plurality of slats; and
a support mechanism that interconnects the plurality of slats, a longitudinal direction of which is oriented in a horizontal direction, and supports the plurality of slats suspended in a vertical direction, wherein
at a boundary between a daylighting slat group composed of a plurality of daylighting slats in an upper position in the vertical direction and a light-shielding slat group composed of a plurality of light-shielding slats in a lower position in the vertical direction, the daylighting slats and the light-shielding slats are arranged consecutively, and
the support mechanism includes a lifting/lowering member that causes the daylighting slat group to be stored or extend independently.

2. The daylighting blind according to claim 1, wherein the support mechanism is a mechanism to store the daylighting slat group and store the light-shielding slat group after the daylighting slat group is stored.

3. The daylighting blind according to claim 1, wherein the support mechanism includes: a storage box that stores the plurality of slats; the lifting/lowering member having one system shared by the plurality of daylighting slats and the plurality of light-shielding slats; and a pulley connected to the storage box and supporting the lifting/lowering member.

4. The daylighting blind according to claim 1, wherein the support mechanism includes the lifting/lowering member having two systems each provided for a corresponding one of the daylighting slat group and the light-shielding slat group, and the support mechanism causes the daylight slat group and the light-shielding slat group to be stored independently of each other by using the lifting/lowering member having the two systems.

5. The daylighting blind according to claim 4, further comprising two rotation shafts each supporting a corresponding one of the two systems of the lifting/lowering member.

6. The daylighting blind according to claim 1, further comprising a diffusing slat group composed of a plurality of diffusing slats disposed below the light-shielding slat group in the vertical direction.

7. The daylighting blind according to claim 6, wherein the support mechanism includes the lifting/lowering member having three systems each provided for a corresponding one of the daylighting slat group, the light-shielding slat group, and the diffusing slat group, and the support mechanism causes the daylighting slat group, the light-shielding slat group, and the diffusing slat group to be stored independently of one another by using the lifting/lowering member having the three systems.

8. The daylighting blind according to claim 6, further comprising three rotation shafts each supporting a corresponding one of the three systems of the lifting/lowering member.

9. The daylighting blind according to claim 1, wherein a length of the light-shielding slat group, composed of the plurality of light-shielding slats, in the vertical direction is greater than a length of a window in the vertical direction.

10. A daylighting device comprising:
a first substrate having a light transmitting property;
a second substrate having a light transmitting property and disposed opposing the first substrate; and
a daylighting blind disposed between the first substrate and the second substrate,
wherein
the daylighting blind according to claim 1 is used as the daylighting blind.

11. A lighting system comprising:
a daylighting device;
room lighting equipment;
a detection section that detects brightness in a room; and
a control section that controls the room lighting equipment and the control section,
wherein
the daylighting blind according to claim 1 is used as the daylighting device.

12. The daylighting blind according to claim 2, wherein the support mechanism includes: a storage box that stores the plurality of slats; the lifting/lowering member having one system shared by the plurality of daylighting slats and the plurality of light-shielding slats; and a pulley connected to the storage box and supporting the lifting/lowering member.

13. The daylighting blind according to claim 7, further comprising three rotation shafts each supporting a corresponding one of the three systems of the lifting/lowering member.

14. A lighting system comprising:
a daylighting device;
room lighting equipment;
a detection section that detects brightness in a room; and
a control section that controls the room lighting equipment and the control section,
wherein
the daylight device according to claim 10 is used as the daylight device.
